(19) United States
(12) Patent Application Publication
(10) Pub. No.: US 2013/0300916 A1
(43) Pub. Date: Nov. 14, 2013

(54) ZOOM LENS SYSTEM, IMAGING DEVICE AND CAMERA

(71) Applicant: PANASONIC CORPORATION, Osaka (JP)

(72) Inventors: Yoshio MATSUMURA, Osaka (JP); Katsu YAMADA, Osaka (JP)

(21) Appl. No.: 13/944,648

(22) Filed: Jul. 17, 2013

Related U.S. Application Data
(63) Continuation of application No. PCT/JP2011/006856, filed on Dec. 7, 2011.

(30) Foreign Application Priority Data
Jan. 18, 2011 (JP) 2011-007455

(51) Int. Cl. G02B 15/14

(52) U.S. Cl. CPC G02B 15/14
USPC 348/345; 359/683

(57) ABSTRACT

A zoom lens system, in order from an object side to an image side, comprising: a first lens unit having positive optical power; and at least one subsequent lens unit, wherein in zooming from a wide-angle limit to a telephoto limit at the time of image taking, an interval between the first lens unit and a lens unit which is one of the at least one subsequent lens unit varies, the condition: f_{T}/f_{W}>10.5 (f_{W}: a focal length of the entire system at a wide-angle limit, f_{T}: a focal length of the entire system at a telephoto limit) is satisfied, and at least one lens element among all the lens elements constituting the lens system satisfies the condition: ((θ_{1G}g−φ_{1G}F)+0.0018×φ_{1G}d)/(φ_{1G}F−φ_{1G}C)>0.8978 (φ_{1G}n: a refractive power to the n-line of the first lens unit).

### RELATED APPLICATIONS

This application is a Continuation of International Application No. PCT/JP2011/006856, filed on Dec. 7, 2011, which in turn claims the benefit of Japanese Application No. 2011-007455, filed on Jan. 18, 2011, the disclosures of which Applications are incorporated by reference herein.

### BACKGROUND

1. Field

The present disclosure relates to zoom lens systems, imaging devices, and cameras.

2. Description of the Related Art

In recent years, digital still cameras and digital video cameras (simply referred to as “digital cameras”, hereinafter) are rapidly spreading which employ imaging devices including imaging optical systems of high optical performance corresponding to solid-state image sensors of high pixel density, such as CCDs, CMOSs, and the like. Among the digital cameras of high optical performance, in particular, a compact digital camera including a zoom lens system having a very high zoom ratio is strongly desired from a convenience point of view. Further, a zoom lens system having a wide angle range where the photographing field is large is also desired.

Various kinds of zoom lenses as follows are proposed for the above-mentioned compact digital camera.

Japanese Laid-Open Patent Publication No. 2005-316047 discloses a zoom lens, in order from the object side to the image side, comprising two lens units of positive and negative, and at least one subsequent lens unit, wherein at least one of the first and second lens units moves in zooming.

Japanese Laid-Open Patent Publication No. 2007-226142 discloses a zoom lens, in order from the object side to the image side, comprising three lens units of positive, negative, and positive, wherein the intervals between adjacent lens units vary in zooming.

Japanese Laid-Open Patent Publication No. 2007-298555 discloses a zoom lens, in order from the object side to the image side, comprising two lens units of positive and negative, and a subsequent lens unit, wherein the interval between the first and second lens units varies in zooming.

Japanese Laid-Open Patent Publication No. 2010-026247 discloses a zoom lens comprising a most object side lens unit and subsequent lens units, and having an aspheric cemented surface.

Japanese Laid-Open Patent Publication No. 2010-054667 discloses a zoom lens, in order from the object side to the image side, comprising two lens units of positive and negative, and a subsequent lens unit, wherein the intervals between the respective lens units vary in zooming, and the first lens unit includes a cemented lens.

### SUMMARY

The present disclosure provides a zoom lens system having, as well as a high resolution, a small size and a view angle of about 80° at a wide-angle limit, which is satisfactorily adaptable for wide-angle image taking, and further having a very high zoom ratio of 10 or more. Further, the present disclosure provides an imaging device employing the zoom lens system, and a compact camera employing the imaging device.

The novel concepts disclosed herein were achieved in order to solve the foregoing problems in the related art, and herein is disclosed:

a zoom lens system having a plurality of lens units, each lens unit comprising at least one lens element,

the zoom lens system, in order from an object side to an image side, comprising:

a first lens unit having positive optical power; and

at least one subsequent lens unit, wherein

in zooming from a wide-angle limit to a telephoto limit at the time of image taking, an interval between the first lens unit and a lens unit which is one of the at least one subsequent lens unit varies,

the following condition (a) is satisfied, and

at least one lens element among all the lens elements constituting the lens system satisfies the following condition (1):

((φ_{1G}g−φ_{1G}F)+0.0018×φ_{1G}d)/(φ_{1G}F−φ_{1G}C)>0.8978 (1)

f_{T}/f_{W}>10.5 (a)

where

φ_{1G}n is a refractive power to the n-line of the first lens unit (“n” is “d”, “F”, “C”, or “g”),

f_{W} is a focal length of the entire system at a wide-angle limit, and

f_{T} is a focal length of the entire system at a telephoto limit.

The novel concepts disclosed herein were achieved in order to solve the foregoing problems in the related art, and herein is disclosed:

an imaging device capable of outputting an optical image of an object as an electric image signal, comprising:

a zoom lens system that forms an optical image of the object; and

an image sensor that converts the optical image formed by the zoom lens system into the electric image signal, wherein

the zoom lens system is a zoom lens system having a plurality of lens units, each lens unit comprising at least one lens element,

the zoom lens system, in order from an object side to an image side, comprising:

a first lens unit having positive optical power; and

at least one subsequent lens unit, wherein

in zooming from a wide-angle limit to a telephoto limit at the time of image taking, an interval between the first lens unit and a lens unit which is one of the at least one subsequent lens unit varies,

the following condition (a) is satisfied, and

at least one lens element among all the lens elements constituting the lens system satisfies the following condition (1):

((φ_{1G}g−φ_{1G}F)+0.0018×φ_{1G}d)/(φ_{1G}F−φ_{1G}C)>0.8978 (1)

f_{T}/f_{W}>10.5 (a)

where

φ_{1G}n is a refractive power to the n-line of the first lens unit (“n” is “d”, “F”, “C”, or “g”),

f_{W} is a focal length of the entire system at a wide-angle limit, and

f_{T} is a focal length of the entire system at a telephoto limit.

The novel concepts disclosed herein were achieved in order to solve the foregoing problems in the related art, and herein is disclosed:

a camera for converting an optical image of an object into an electric image signal and then performing at least one of displaying and storing of the converted image signal, comprising:

an imaging device including a zoom lens system that forms an optical image of the object and an image sensor that converts the optical image formed by the zoom lens system into the electric image signal, wherein

the zoom lens system is a zoom lens system having a plurality of lens units, each lens unit comprising at least one lens element,

the zoom lens system, in order from an object side to an image side, comprising:

a first lens unit having positive optical power; and

at least one subsequent lens unit, wherein

in zooming from a wide-angle limit to a telephoto limit at the time of image taking, an interval between the first lens unit and a lens unit which is one of the at least one subsequent lens unit varies,

the following condition (a) is satisfied, and

at least one lens element among all the lens elements constituting the lens system satisfies the following condition (1):

((φ_{1G}g−φ_{1G}F)+0.0018×φ_{1G}d)/(φ_{1G}F−φ_{1G}C)>0.8978 (1)

f_{T}/f_{W}>10.5 (a)

where

φ_{1G}n is a refractive power to the n-line of the first lens unit (“n” is “d”, “F”, “C”, or “g”),

f_{W} is a focal length of the entire system at a wide-angle limit, and

f_{T} is a focal length of the entire system at a telephoto limit.

The zoom lens system according to the present disclosure has, as well as a high resolution, a small size and a view angle of about 80° at a wide-angle limit, which is satisfactorily adaptable for wide-angle image taking. Further, the zoom lens system has a very high zoom ratio of about 10 to 40.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a zoom lens system according to Embodiment 1 (Numerical Example 1);

FIG. 2 is a longitudinal aberration diagram of an infinity in-focus condition of the zoom lens system according to Numerical Example 1;

FIG. 3 is a lateral aberration diagram of the zoom lens system according to Numerical Example 1 at a telephoto limit in a basic state where image blur compensation is not performed and in an image blur compensation state;

FIG. 4 is a lens arrangement diagram showing an infinity in-focus condition of a zoom lens system according to Embodiment 2 (Numerical Example 2);

FIG. 5 is a longitudinal aberration diagram of an infinity in-focus condition of the zoom lens system according to Numerical Example 2;

FIG. 6 is a lateral aberration diagram of the zoom lens system according to Numerical Example 2 at a telephoto limit in a basic state where image blur compensation is not performed and in an image blur compensation state;

FIG. 7 is a lens arrangement diagram showing an infinity in-focus condition of a zoom lens system according to Embodiment 3 (Numerical Example 3);

FIG. 8 is a longitudinal aberration diagram of an infinity in-focus condition of the zoom lens system according to Numerical Example 3;

FIG. 9 is a lateral aberration diagram of the zoom lens system according to Numerical Example 3 at a telephoto limit in a basic state where image blur compensation is not performed and in an image blur compensation state;

FIG. 10 is a lens arrangement diagram showing an infinity in-focus condition of a zoom lens system according to Embodiment 4 (Numerical Example 4);

FIG. 11 is a longitudinal aberration diagram of an infinity in-focus condition of the zoom lens system according to Numerical Example 4;

FIG. 12 is a lateral aberration diagram of the zoom lens system according to Numerical Example 4 at a telephoto limit in a basic state where image blur compensation is not performed and in an image blur compensation state;

FIG. 13 is a lens arrangement diagram showing an infinity in-focus condition of a zoom lens system according to Embodiment 5 (Numerical Example 5);

FIG. 14 is a longitudinal aberration diagram of an infinity in-focus condition of the zoom lens system according to Numerical Example 5;

FIG. 15 is a lateral aberration diagram of the zoom lens system according to Numerical Example 5 at a telephoto limit in a basic state where image blur compensation is not performed and in an image blur compensation state;

FIG. 16 is a lens arrangement diagram showing an infinity in-focus condition of a zoom lens system according to Embodiment 6 (Numerical Example 6);

FIG. 17 is a longitudinal aberration diagram of an infinity in-focus condition of the zoom lens system according to Numerical Example 6;

FIG. 18 is a lateral aberration diagram of the zoom lens system according to Numerical Example 6 at a telephoto limit in a basic state where image blur compensation is not performed and in an image blur compensation state; and

FIG. 19 is a schematic construction diagram of a digital still camera according to Embodiment 7.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiments 1 to 6

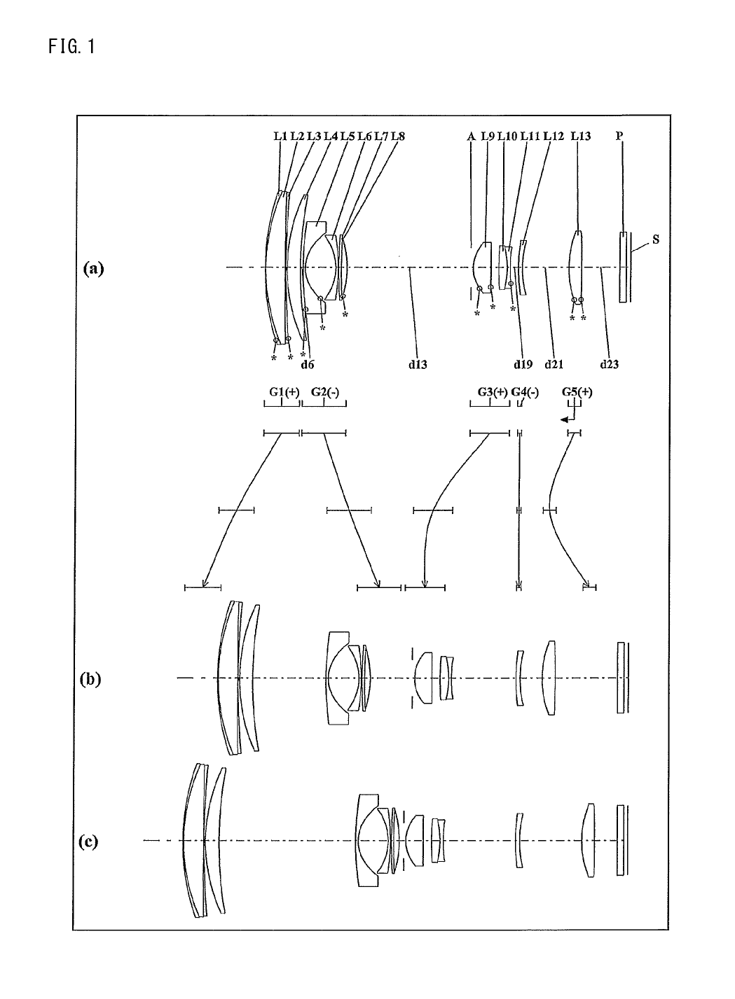

FIGS. 1, 4, 7, 10, 13, and 16 are lens arrangement diagrams of zoom lens systems according to Embodiments 1 to 6, respectively.

Each of FIGS. 1, 4, 7, 10, 13, and 16 shows a zoom lens system in an infinity in-focus condition. In each Fig., part (a) shows a lens configuration at a wide-angle limit (in the minimum focal length condition: focal length f_{W}), part (b) shows a lens configuration at a middle position (in an intermediate focal length condition: focal length f_{M}=√(f_{W}*f_{T})), and part (c) shows a lens configuration at a telephoto limit (in the maximum focal length condition: focal length f_{T}). Further, in each Fig., an arrow of straight or curved line provided between part (a) and part (b) indicates the movement of each lens unit from a wide-angle limit through a middle position to a telephoto limit. Moreover, in each Fig., an arrow imparted to a lens unit indicates focusing from an infinity in-focus condition to a close-object in-focus condition. That is, the arrow indicates the moving direction at the time of focusing from an infinity in-focus condition to a close-object in-focus condition.

Further, in FIGS. 1, 4, 7, 10, 13, and 16, an asterisk “*” imparted to a particular surface indicates that the surface is aspheric. In each Fig., symbol (+) or (−) imparted to the symbol of each lens unit corresponds to the sign of the optical power of the lens unit. In each Fig., the straight line located on the most right-hand side indicates the position of the image surface S. On the object side relative to the image surface S (i.e., between the image surface S and the most image side lens surface), a plane parallel plate P equivalent to an optical low-pass filter or a face plate of an image sensor is provided.

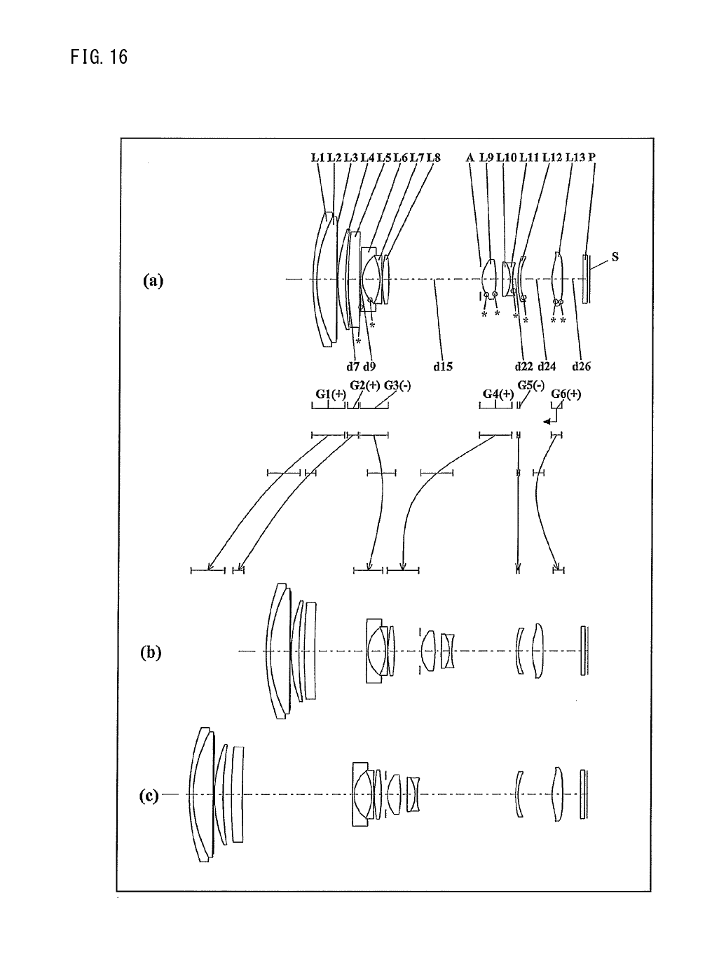

Further, in FIGS. 1, 4, 7, 10, and 13, an aperture diaphragm A is provided closest to the object side in the third lens unit G3, i.e., between the second lens unit G2 and the third lens unit G3. In addition, in FIG. 16, an aperture diaphragm A is provided closest to the object side in the fourth lens unit G4, i.e., between the third lens unit G3 and the fourth lens unit G4.

### Embodiment 1

As shown in FIG. 1, the first lens unit G1, in order from the object side to the image side, comprises: a negative meniscus first lens element L1 with the convex surface facing the object side; a positive meniscus second lens element L2 with the convex surface facing the object side; a negative meniscus third lens element L3 with the convex surface facing the object side; and a positive meniscus fourth lens element L4 with the convex surface facing the object side. Among these, the first lens element L1, the second lens element L2, and the third lens element L3 are cemented with each other. The first lens element L1 has an aspheric object side surface, and the third lens element L3 has an aspheric image side surface. The first lens element L1 and the third lens element L3 are lens elements made of a fine particle dispersed material.

The second lens unit G2, in order from the object side to the image side, comprises: a negative meniscus fifth lens element L5 with the convex surface facing the object side; a negative meniscus sixth lens element L6 with the convex surface facing the image side; a negative meniscus seventh lens element L7 with the convex surface facing the object side; and a bi-convex eighth lens element L8. Among these, the seventh lens element L7 and the eighth lens element L8 are cemented with each other. The fifth lens element L5 has two aspheric surfaces, and the eighth lens element L8 has an aspheric image side surface. The eighth lens element L8 is a lens element made of a fine particle dispersed material.

The third lens unit G3, in order from the object side to the image side, comprises: a positive meniscus ninth lens element L9 with the convex surface facing the object side; a bi-convex tenth lens element L10; and a bi-concave eleventh lens element L11. Among these, the tenth lens element L10 and the eleventh lens element L11 are cemented with each other. The ninth lens element L9 has two aspheric surfaces, and the eleventh lens element L11 has an aspheric image side surface.

The fourth lens unit G4 comprises solely a negative meniscus twelfth lens element L12 with the convex surface facing the object side.

The fifth lens unit G5 comprises solely a bi-convex thirteenth lens element L13. The thirteenth lens element L13 has two aspheric surfaces.

A plane parallel plate P is provided on the object side relative to the image surface S (between the image surface S and the thirteenth lens element L13).

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 does not move, and the fifth lens unit G5 moves to the image side with locus of a convex to the object side.

That is, in zooming, the first lens unit G1, the second lens unit G2, the third lens unit G3, and the fifth lens unit G5 individually move along the optical axis such that the interval between the first lens unit G1 and the second lens unit G2 increases, that the interval between the second lens unit G2 and the third lens unit G3 decreases, and that the interval between the third lens unit G3 and the fourth lens unit G4 increases.

In focusing from an infinity in-focus condition to a close-object in-focus condition, the fifth lens unit G5 moves to the object side along the optical axis.

By moving the third lens unit G3 in a direction perpendicular to the optical axis, image point movement caused by vibration of the entire system can be compensated. That is, image blur caused by hand blurring, vibration and the like can be compensated optically.

### Embodiment 2

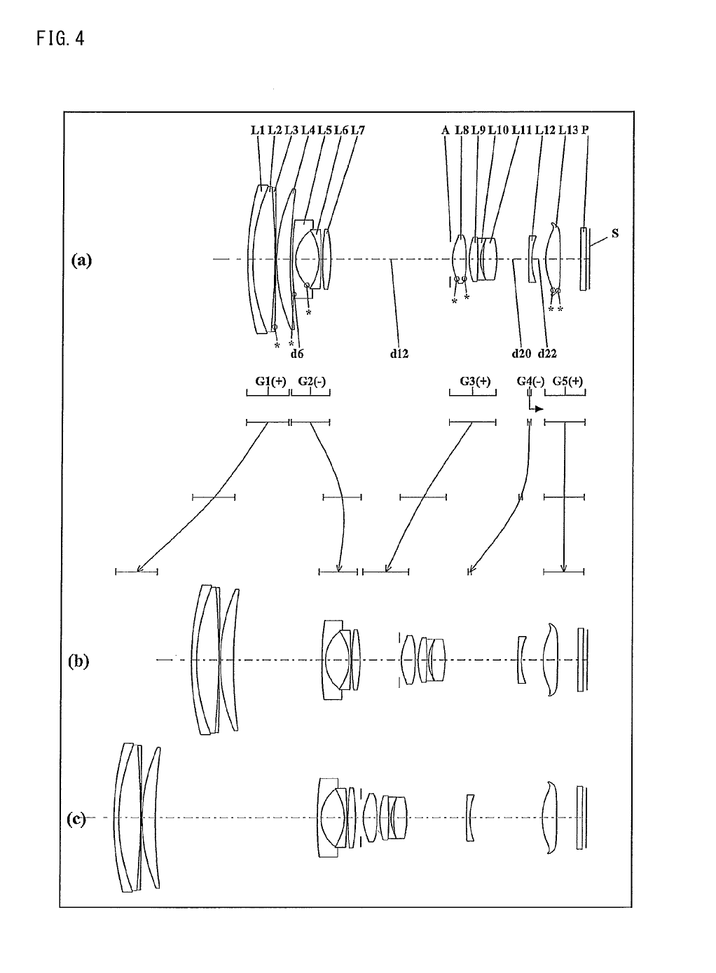

As shown in FIG. 4, the first lens unit G1, in order from the object side to the image side, comprises: a negative meniscus first lens element L1 with the convex surface facing the object side; a bi-convex second lens element L2; a negative meniscus third lens element L3 with the convex surface facing the image side; and a positive meniscus fourth lens element L4 with the convex surface facing the object side. Among these, the first lens element L1, the second lens element L2, and the third lens element L3 are cemented with each other. The third lens element L3 has an aspheric image side surface. The third lens element L3 is a lens element made of a fine particle dispersed material.

The second lens unit G2, in order from the object side to the image side, comprises: a negative meniscus fifth lens element L5 with the convex surface facing the object side; a negative meniscus sixth lens element L6 with the convex surface facing the image side; and a bi-convex seventh lens element L7. The fifth lens element L5 has two aspheric surfaces.

The third lens unit G3, in order from the object side to the image side, comprises: a bi-convex eighth lens element L8; a bi-convex ninth lens element L9, a bi-concave tenth lens element L10, and a bi-convex eleventh lens element L11. Among these, the ninth lens element L9 and the tenth lens element L10 are cemented with each other. The eighth lens element L8 has two aspheric surfaces. The eleventh lens element L11 is a lens element made of a fine particle dispersed material.

The fourth lens unit G4 comprises solely a negative meniscus twelfth lens element L12 with the convex surface facing the object side.

The fifth lens unit G5 comprises solely a bi-convex thirteenth lens element L13. The thirteenth lens element L13 has two aspheric surfaces.

A plane parallel plate P is provided on the object side relative to the image surface S (between the image surface S and the thirteenth lens element L13).

In zooming from a wide-angle limit to a telephoto limit at the time of image taking, the first lens unit G1 moves to the object side, the second lens unit G2 moves to the image side with locus of a convex to the image side, the third lens unit G3 moves to the object side together with the aperture diaphragm A, the fourth lens unit G4 moves to the object side, and the fifth lens unit G5 does not move.

That is, in zooming, the first lens unit G1, the second lens unit G2, the third lens unit G3, and the fourth lens unit G4 individually move along the optical axis such that the interval between the first lens unit G1 and the second lens unit G2 increases, that the interval between the second lens unit G2 and the third lens unit G3 decreases, and that the interval between the fourth lens unit G4 and the fifth lens unit G5 increases.

In focusing from an infinity in-focus condition to a close-object in-focus condition, the fourth lens unit G4 moves to the image side along the optical axis.

By moving the third lens unit G3 in a direction perpendicular to the optical axis, image point movement caused by vibration of the entire system can be compensated. That is, image blur caused by hand blurring, vibration and the like can be compensated optically.

### Embodiment 3

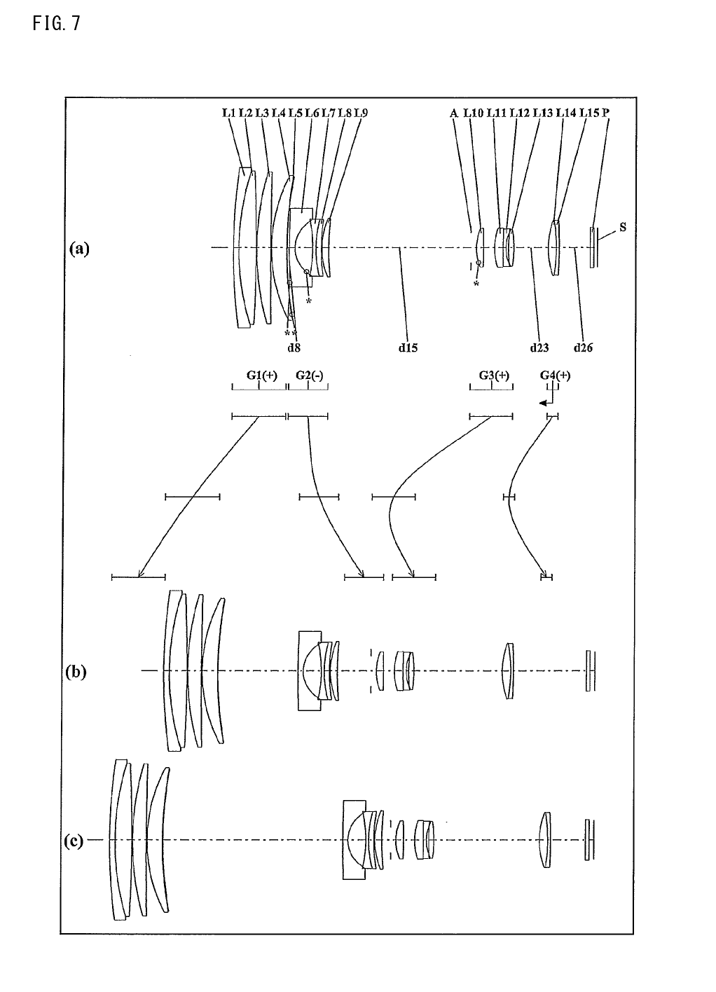

As shown in FIG. 7, the first lens unit G1, in order from the object side to the image side, comprises: a negative meniscus first lens element L1 with the convex surface facing the object side; a bi-convex second lens element L2; a positive meniscus third lens element L3 with the convex surface facing the object side; a positive meniscus fourth lens element L4 with the convex surface facing the object side; and a negative meniscus fifth lens element L5 with the convex surface facing the object side. Among these, the first lens element L1 and the second lens element L2 are cemented with each other, and the fourth lens element L4 and the fifth lens element L5 are cemented with each other. The fifth lens element L5 has an aspheric image side surface. Further, the fifth lens element L5 is a lens element made of a fine particle dispersed material.

The second lens unit G2, in order from the object side to the image side, comprises: a negative meniscus sixth lens element L6 with the convex surface facing the object side; a bi-concave seventh lens element L7; a positive meniscus eighth lens element L8 with the convex surface facing the object side; and a positive meniscus ninth lens element L9 with the convex surface facing the object side. Among these, the seventh lens element L7 and the eighth lens element L8 are cemented with each other. The sixth lens element L6 has two aspheric surfaces. The eighth lens element L8 is a lens element made of a fine particle dispersed material.

The third lens unit G3, in order from the object side to the image side, comprises: a bi-convex tenth lens element L10; a positive meniscus eleventh lens element L11 with the convex surface facing the object side; a negative meniscus twelfth lens element L12 with the convex surface facing the object side; and a bi-convex thirteenth lens element L13. Among these, the eleventh lens element L11 and the twelfth lens element L12 are cemented with each other. The tenth lens element L10 has an aspheric object side surface.

The fourth lens unit G4, in order from the object side to the image side, comprises: a bi-convex fourteenth lens element L14; and a negative meniscus fifteenth lens element L15 with the convex surface facing the image side. The fourteenth lens element L14 and the fifteenth lens element L15 are cemented with each other.

A plane parallel plate P is provided on the object side relative to the image surface S (between the image surface S and the fifteenth lens element L15).

In zooming from a wide-angle limit to a telephoto limit at the time of image taking, the first lens unit G1 moves to the object side, the second lens unit G2 moves to the image side, the third lens unit G3 moves, together with the aperture diaphragm A, to the object side with locus of a convex to the object side, and the fourth lens unit G4 moves to the object side with locus of a convex to the object side.

That is, in zooming, the individual lens units move along the optical axis such that the interval between the first lens unit G1 and the second lens unit G2 increases, and that the interval between the second lens unit G2 and the third lens unit G3 decreases.

In focusing from an infinity in-focus condition to a close-object in-focus condition, the fourth lens unit G4 moves to the object side along the optical axis.

By moving the third lens unit G3 in a direction perpendicular to the optical axis, image point movement caused by vibration of the entire system can be compensated. That is, image blur caused by hand blurring, vibration and the like can be compensated optically.

### Embodiment 4

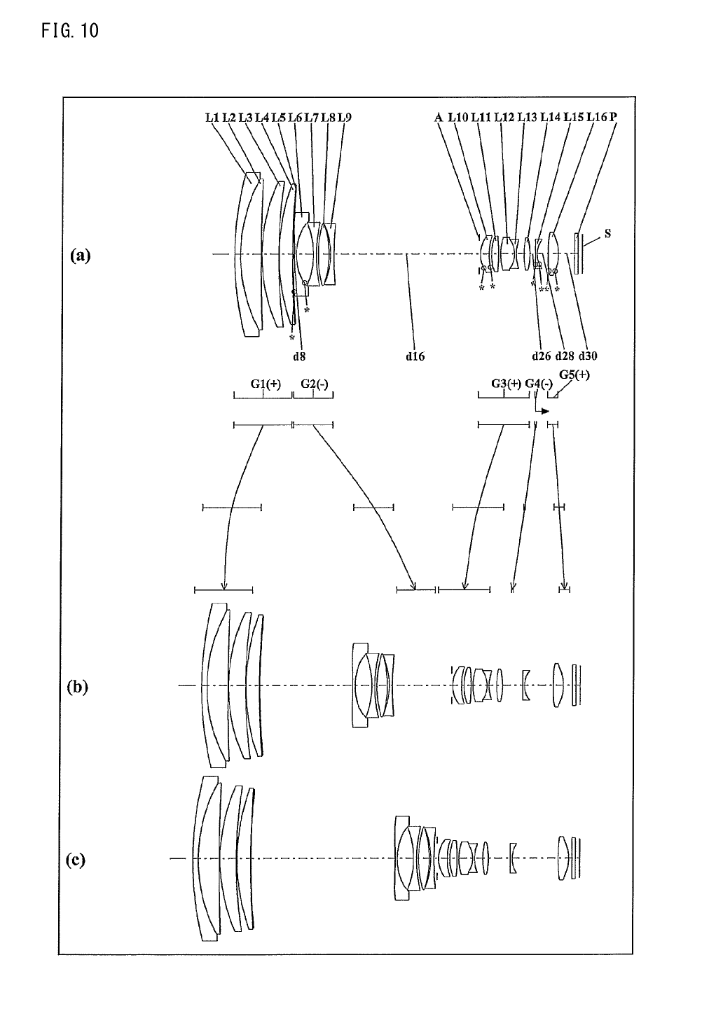

As shown in FIG. 10, the first lens unit G1, in order from the object side to the image side, comprises: a negative meniscus first lens element L1 with the convex surface facing the object side; a positive meniscus second lens element L2 with the convex surface facing the object side; a positive meniscus third lens element L3 with the convex surface facing the object side; a positive meniscus fourth lens element L4 with the convex surface facing the object side; and a negative meniscus fifth lens element L5 with the convex surface facing the object side. Among these, the first lens element L1 and the second lens element L2 are cemented with each other, and the fourth lens element L4 and the fifth lens element L5 are cemented with each other. The fifth lens element L5 is a lens element made of a fine particle dispersed material.

The second lens unit G2, in order from the object side to the image side, comprises: a bi-concave sixth lens element L6; a bi-concave seventh lens element L7; a bi-convex eighth lens element L8; and a bi-concave ninth lens element L9. The sixth lens element L6 has two aspheric surfaces.

The third lens unit G3, in order from the object side to the image side, comprises: a positive meniscus tenth lens element L10 with the convex surface facing the object side; a bi-convex eleventh lens element L11; a bi-convex twelfth lens element L12; a bi-concave thirteenth lens element L13; and a bi-convex fourteenth lens element L14. Among these, the twelfth lens element L12 and the thirteenth lens element L13 are cemented with each other. The tenth lens element L10 has two aspheric surfaces.

The fourth lens unit G4 comprises solely a bi-concave fifteenth lens element L15. The fifteenth lens element L15 has two aspheric surfaces.

The fifth lens unit G5 comprises solely a bi-convex sixteenth lens element L16. The sixteenth lens element L16 has two aspheric surfaces. The sixteenth lens element L16 is a lens element made of a fine particle dispersed material.

A plane parallel plate P is provided on the object side relative to the image surface S (between the image surface S and the sixteenth lens element L16).

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, and the fifth lens unit G5 moves to the image side.

That is, in zooming, the individual lens units move along the optical axis such that the interval between the first lens unit G1 and the second lens unit G2 increases, that the interval between the second lens unit G2 and the third lens unit G3 decreases, and that the interval between the fourth lens unit G4 and the fifth lens unit G5 increases.

In focusing from an infinity in-focus condition to a close-object in-focus condition, the fourth lens unit G4 moves to the image side along the optical axis.

By moving the third lens unit G3 in a direction perpendicular to the optical axis, image point movement caused by vibration of the entire system can be compensated. That is, image blur caused by hand blurring, vibration and the like can be compensated optically.

### Embodiment 5

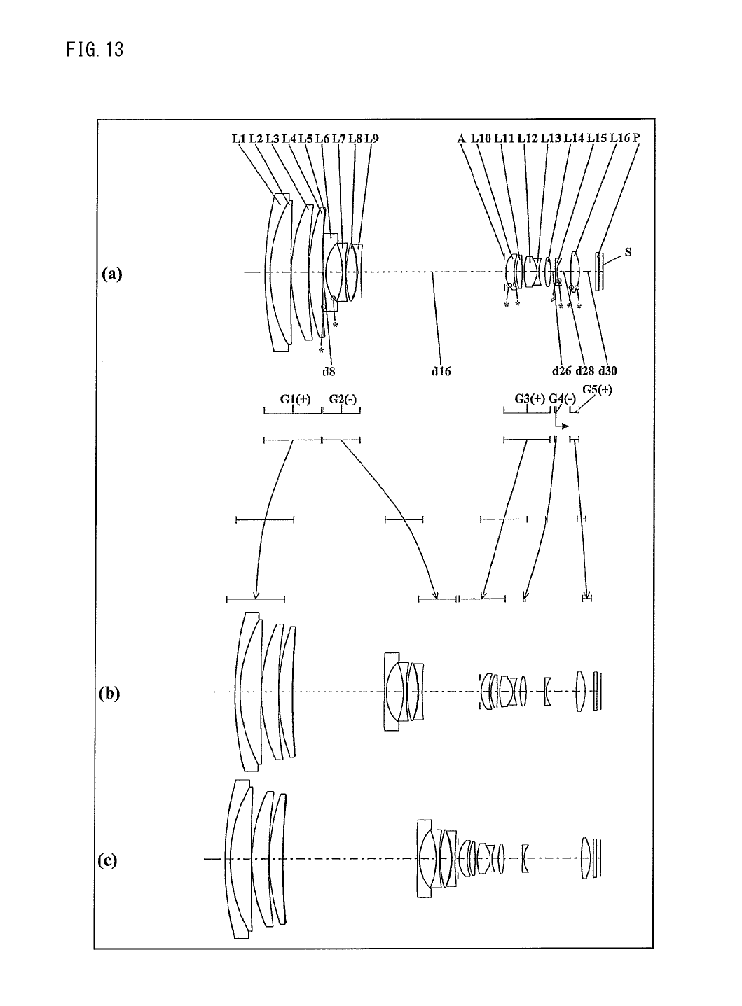

As shown in FIG. 13, the first lens unit G1, in order from the object side to the image side, comprises: a negative meniscus first lens element L1 with the convex surface facing the object side; a positive meniscus second lens element L2 with the convex surface facing the object side; a positive meniscus third lens element L3 with the convex surface facing the object side; a positive meniscus fourth lens element L4 with the convex surface facing the object side; and a negative meniscus fifth lens element L5 with the convex surface facing the object side. Among these, the first lens element L1 and the second lens element L2 are cemented with each other, and the fourth lens element L4 and the fifth lens element L5 are cemented with each other. The fifth lens element L5 is a lens element made of a fine particle dispersed material.

The second lens unit G2, in order from the object side to the image side, comprises: a bi-concave sixth lens element L6; a bi-concave seventh lens element L7; a bi-convex eighth lens element L8; and a bi-concave ninth lens element L9. The sixth lens element L6 has two aspheric surfaces.

The third lens unit G3, in order from the object side to the image side, comprises: a positive meniscus tenth lens element L10 with the convex surface facing the object side; a bi-convex eleventh lens element L11; a bi-convex twelfth lens element L12; a bi-concave thirteenth lens element L13; and a bi-convex fourteenth lens element L14. Among these, the twelfth lens element L12 and the thirteenth lens element L13 are cemented with each other. The tenth lens element L10 has two aspheric surfaces.

The fourth lens unit G4 comprises solely a bi-concave fifteenth lens element L15. The fifteenth lens element L15 has two aspheric surfaces.

The fifth lens unit G5 comprises solely a bi-convex sixteenth lens element L16. The sixteenth lens element L16 has two aspheric surfaces. The sixteenth lens element L16 is a lens element made of a fine particle dispersed material.

A plane parallel plate P is provided on the object side relative to the image surface S (between the image surface S and the sixteenth lens element L16).

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, and the fifth lens unit G5 moves to the image side.

That is, in zooming, the individual lens units move along the optical axis such that the interval between the first lens unit G1 and the second lens unit G2 increases, that the interval between the second lens unit G2 and the third lens unit G3 decreases, and that the interval between the fourth lens unit G4 and the fifth lens unit G5 increases.

In focusing from an infinity in-focus condition to a close-object in-focus condition, the fourth lens unit G4 moves to the image side along the optical axis.

By moving the third lens unit G3 in a direction perpendicular to the optical axis, image point movement caused by vibration of the entire system can be compensated. That is, image blur caused by hand blurring, vibration and the like can be compensated optically.

### Embodiment 6

As shown in FIG. 16, the first lens unit G1, in order from the object side to the image side, comprises: a negative meniscus first lens element L1 with the convex surface facing the object side; a bi-convex second lens element L2; a bi-concave third lens element L3; and a positive meniscus fourth lens element L4 with the convex surface facing the object side. Among these, the first lens element L1, the second lens element L2, and the third lens element L3 are cemented with each other. In the surface data of the corresponding Numerical Example described later, surface number 2 is imparted to an adhesive layer between the first lens element L1 and the second lens element L2. The third lens element L3 is a lens element made of a fine particle dispersed material.

The second lens unit G2 comprises solely a positive meniscus fifth lens element L5 with the convex surface facing the object side.

The third lens unit G3, in order from the object side to the image side, comprises: a negative meniscus sixth lens element L6 with the convex surface facing the object side; a bi-concave seventh lens element L7; and a bi-convex eighth lens element L8. The sixth lens element L6 has two aspheric surfaces.

The fourth lens unit G4, in order from the object side to the image side, comprises: a bi-convex ninth lens element L9, a bi-convex tenth lens element L10, and a bi-concave eleventh lens element L11. Among these, the tenth lens element L10 and the eleventh lens element L11 are cemented with each other. In the surface data of the corresponding Numerical Example described later, surface number 20 is imparted to an adhesive layer between the tenth lens element L10 and the eleventh lens element L11. The ninth lens element L9 has two aspheric surfaces. The eleventh lens element L11 has an aspheric image side surface.

The fifth lens unit G5 comprises solely a negative meniscus twelfth lens element L12 with the convex surface facing the object side. The twelfth lens element L12 has an aspheric image side surface.

The sixth lens unit G6 comprises solely a bi-convex thirteenth lens element L13. The thirteenth lens element L13 has two aspheric surfaces.

A plane parallel plate P is provided on the object side relative to the image surface S (between the image surface S and the thirteenth lens element L13).

In zooming from a wide-angle limit to a telephoto limit at the time of image taking, the first lens unit G1 moves to the object side, the second lens unit G2 moves to the object side, the third lens unit G3 moves to the object side with locus of a convex to the image side, the fourth lens unit G4 moves to the object side together with the aperture diaphragm A, the fifth lens unit G5 does not move, and the sixth lens unit G6 moves to the image side with locus of a convex to the object side.

That is, in zooming, the first lens unit G1, the second lens unit G2, the third lens unit G3, the fourth lens unit G4, and the sixth lens unit G6 individually move along the optical axis such that the interval between the second lens unit G2 and the third lens unit G3 increases, that the interval between the third lens unit G3 and the fourth lens unit G4 decreases, and that the interval between the fourth lens unit G4 and the fifth lens unit G5 increases.

In focusing from an infinity in-focus condition to a close-object in-focus condition, the sixth lens unit G6 moves to the object side along the optical axis.

By moving the fourth lens unit G4 in a direction perpendicular to the optical axis, image point movement caused by vibration of the entire system can be compensated. That is, image blur caused by hand blurring, vibration and the like can be compensated optically.

In the present disclosure, the fine particle dispersed material, which is a material of some lens elements, is a material obtained by dispersing inorganic particles in a resin as described later. There is no particular limit to the kinds of resin and inorganic particles, and any resin and inorganic particles may be adopted so long as they are available for lens elements. Further, there is no particular limit to the combination of resin and inorganic particles, and any combination of resin and inorganic particles may be adopted so long as a lens element having desired refractive index, Abbe number, partial dispersion ratio and the like can be obtained.

As described above, Embodiments 1 to 6 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

The following description is given for conditions that a zoom lens system like the zoom lens systems according to Embodiments 1 to 6 can satisfy. Here, a plurality of beneficial conditions is set forth for the zoom lens system according to each embodiment. A construction that satisfies all the plural conditions is most effective for the zoom lens system. However, when an individual condition is satisfied, a zoom lens system having the corresponding effect is obtained.

For example, in a zoom lens system like the zoom lens systems according to Embodiments 1 to 6, which comprises, in order from an object side to an image side, a first lens unit having positive optical power and at least one subsequent lens unit, wherein an interval between the first lens unit and a lens unit which is one of the at least one subsequent lens unit varies in zooming from a wide-angle limit to a telephoto limit at the time of image taking (this lens configuration is referred to as a basic configuration of the embodiment, hereinafter), the following condition (a) is satisfied, and at least one lens element among all the lens elements constituting the lens system satisfies the following condition (1).

((φ_{1G}g−φ_{1G}F)+0.0018×φ_{1G}d)/(φ_{1G}F−φ_{1G}C)>0.8978 (1)

f_{T}/f_{W}>10.5 (a)

where

φ_{1G}n is a refractive power to the n-line of the first lens unit (“n” is “d”, “F”, “C”, or “g”),

f_{W} is a focal length of the entire system at a wide-angle limit, and

f_{T} is a focal length of the entire system at a telephoto limit.

The condition (1) sets forth a change in the refractive power due to the wavelength of the first lens unit. When the condition (1) is not satisfied, it becomes difficult to control a secondary spectrum particularly at a telephoto limit. Then, in order to successfully compensate chromatic aberration, the overall length of the zoom lens system is increased, or the number of lens elements is increased. That is, it becomes difficult to provide compact lens barrel, imaging device, and camera.

When the following condition (1)′ is further satisfied, the above-mentioned effect is achieved more successfully.

((φ_{1G}g−φ_{1G}F)+0.0018×φ_{1G}d)/(φ_{1G}F−φ_{1G}C)>1.0935 (1)′

In a zoom lens system having the basic configuration like the zoom lens systems according to Embodiments 1 to 6, it is beneficial to satisfy the following condition (2):

0.20<(L_{T}×f_{W})/(H_{T}×f_{T})<1.31 (2)

where

L_{T} is an overall length of lens system at a telephoto limit (an optical axial distance from an object side surface of a lens element positioned closest to the object side in the lens system, to an image surface),

f_{W} is a focal length of the entire system at a wide-angle limit,

f_{T} is a focal length of the entire system at a telephoto limit, and

H_{T} is an image height at a telephoto limit.

The condition (2) sets forth the overall length of lens system at a telephoto limit and the zoom ratio. When the value exceeds the upper limit of the condition (2), the overall length of lens system at a telephoto limit is increased relative to the zoom ratio, and thereby the effective diameter of the first lens unit is increased. That is, it becomes difficult to provide compact lens barrel, imaging device, and camera. On the other hand, when the value goes below the lower limit of the condition (2), the overall length of lens system at a telephoto limit is decreased relative to the zoom ratio, which makes it difficult to compensate axial chromatic aberration particularly at a telephoto limit.

When at least one of the following conditions (2)′ and (2)″ is further satisfied, the above-mentioned effect is achieved more successfully.

0.50<(L_{T}×f_{W})/(H_{T}×f_{T}) (2)′

(L_{T}×f_{W})/(H_{T}×f_{T})<0.99 (2)″

In a zoom lens system having the basic configuration like the zoom lens systems according to Embodiments 1 to 6, it is beneficial to satisfy the following condition (3):

0.10<(f₁×f_{W})/(H_{T}×f_{T})<0.73 (3)

where

f₁ is a focal length of the first lens unit,

f_{W} is a focal length of the entire system at a wide-angle limit,

f_{T} is a focal length of the entire system at a telephoto limit, and

H_{T} is an image height at a telephoto limit.

The condition (3) sets forth the focal length of the first lens unit and the zoom ratio. When the value exceeds the upper limit of the condition (3), the focal length of the first lens unit is increased, and thereby the effective diameter of the first lens unit is increased. That is, it becomes difficult to provide compact lens barrel, imaging device, and camera. In addition, it becomes difficult to control distortion at a wide-angle limit. On the other hand, when the value goes below the lower limit of the condition (3), the focal length of the first lens unit is decreased, which makes it difficult to control curvature of field at a wide-angle limit.

When at least one of the following conditions (3)′ and (3)″ is further satisfied, the above-mentioned effect is achieved more successfully.

0.20<(f₁×f_{W})/(H_{T}×f_{T}) (3)′

(f₁×f_{W})/(H_{T}×f_{T})<0.54 (3)″

In a zoom lens system having the basic configuration, in which the second lens unit is located closest to the object side in the subsequent lens unit, like the zoom lens systems according to Embodiments 1 to 6, it is beneficial to satisfy the following condition (4):

11.76<f_{T}/M₂<70.00 (4)

where

f_{T} is a focal length of the entire system at a telephoto limit, and

M₂ is an optical axial thickness of the second lens unit (an optical axial distance from an object side surface of a most object side lens element to an image side surface of a most image side lens element).

The condition (4) sets forth the focal length of the entire system at a telephoto limit and the optical axial thickness of the second lens unit. When the value exceeds the upper limit of the condition (4), the optical axial thickness of the second lens unit is decreased, and thereby the number of lens elements constituting the second lens unit is decreased, which makes it difficult to compensate astigmatism in the entire zooming region, particularly. In addition, the thickness of each of the lens elements constituting the second lens unit is decreased, which makes it difficult to manufacture the lens elements. On the other hand, when the value goes below the lower limit of the condition (4), the optical axial thickness of the second lens unit is increased, and thereby the effective diameter of the first lens unit is increased. That is, it becomes difficult to provide compact lens barrel, imaging device, and camera. In addition, the height of light beam in the first lens unit and the second lens unit is increased, which makes it difficult to control curvature of field at a wide-angle limit.

When at least one of the following conditions (4)′ and (4)″ is further satisfied, the above-mentioned effect is achieved more successfully.

12.13<f_{T}/M₂ (4)′

f_{T}/M₂<30.00 (4)″

In a zoom lens system having the basic configuration like the zoom lens systems according to Embodiments 1 to 6, it is beneficial that at least one of the lens elements constituting the first lens unit is a lens element made of a fine particle dispersed material. When a lens element made of the fine particle dispersed material is not included in the first lens unit, it becomes difficult to suppress deterioration in imaging characteristics with temperature change.

In a zoom lens system having the basic configuration like the zoom lens systems according to Embodiments 1 to 6, it is beneficial that at least one of the lens elements constituting the first lens unit satisfies the following condition (5) or (6):

I) when vd<23

0.0002399×vd²−0.0123×vd+0.8157−θgF<0

II) when 23≦vd<80

θgF>0.66

III) when 80≦vd

0.00003815×vd²−0.006314×vd+0.8239−θgF<0 (5)

−0.00325×vd+0.69−θgF>0 (6)

where

vd is an Abbe number to the d-line of the lens element, and

θgF is a partial dispersion ratio of the lens element, that is a ratio of a difference between a refractive index to the g-line and a refractive index to the F-line, to a difference between the refractive index to the F-line and a refractive index to the C-line.

The conditions (5) and (6) set forth the partial dispersion ratio of the lens element constituting the first lens unit. When the first lens unit includes no lens element that satisfies the condition (5) or (6), it becomes difficult to control a secondary spectrum. Then, in order to successfully compensate chromatic aberration, the overall length of the zoom lens system is increased, or the number of lens elements is increased. That is, it becomes difficult to provide compact lens barrel, imaging device, and camera.

When the following condition (5)′ or (6)′ is further satisfied, the above-mentioned effect is achieved more successfully.

I) when vd<23

0.0002399×vd²−0.0123×vd+0.9157−θgF<0

II) when 23≦vd<80

θgF>0.76

III) when 80≦vd

0.00003815×vd²−0.006314×vd+0.9239−θgF<0 (5)′

−0.00325×vd+0.59−θgF>0 (6)′

The individual lens units constituting the zoom lens systems according to Embodiments 1 to 6 are each composed exclusively of refractive type lens elements that deflect incident light by refraction (that is, lens elements of a type in which deflection is achieved at the interface between media having different refractive indices). However, the present disclosure is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved. Thus, such a configuration is beneficial.

### Embodiment 7

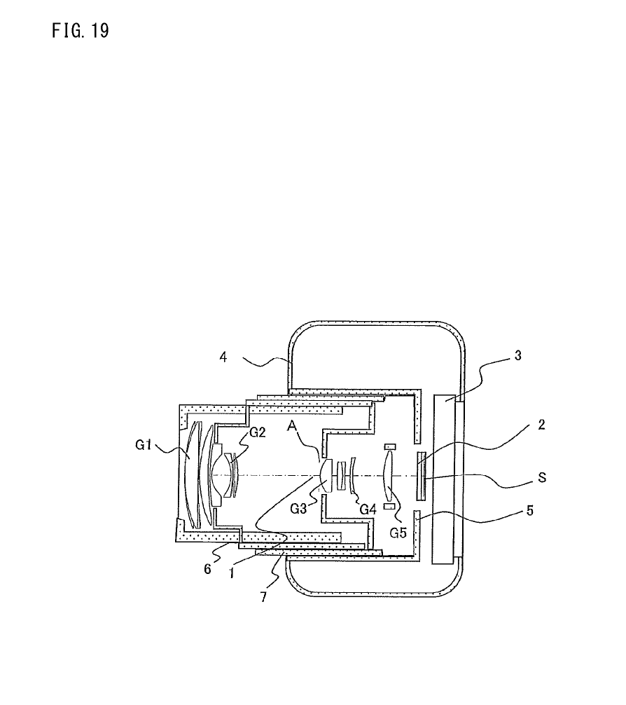

FIG. 19 is a schematic construction diagram of a digital still camera according to Embodiment 7. In FIG. 19, the digital still camera comprises: an imaging device having a zoom lens system 1 and an image sensor 2 composed of a CCD; a liquid crystal display monitor 3; and a body 4. The employed zoom lens system 1 is a zoom lens system according to Embodiment 1. In FIG. 19, the zoom lens system 1, in order from the object side to the image side, comprises a first lens unit G1, a second lens unit G2, an aperture diaphragm A, a third lens unit G3, a fourth lens unit G4, and a fifth lens unit G5. In the body 4, the zoom lens system 1 is arranged on the front side, while the image sensor 2 is arranged on the rear side of the zoom lens system 1. On the rear side of the body 4, the liquid crystal display monitor 3 is arranged, while an optical image of a photographic object generated by the zoom lens system 1 is formed on an image surface S.

The lens barrel comprises a main barrel 5, a moving barrel 6 and a cylindrical cam 7. When the cylindrical cam 7 is rotated, the first lens unit G1, the second lens unit G2, the aperture diaphragm A and the third lens unit G3, the fourth lens unit G4, and the fifth lens unit G5 move to predetermined positions relative to the image sensor 2, so that zooming from a wide-angle limit to a telephoto limit is achieved. The fifth lens unit G5 is movable in an optical axis direction by a motor for focus adjustment.

As such, when the zoom lens system according to Embodiment 1 is employed in a digital still camera, a small digital still camera is obtained that has a high resolution and high capability of compensating the curvature of field and that has a short overall length of lens system at the time of non-use. Here, in the digital still camera shown in FIG. 19, any one of the zoom lens systems according to Embodiments 2 to 6 may be employed in place of the zoom lens system according to Embodiment 1. Further, the optical system of the digital still camera shown in FIG. 19 is applicable also to a digital video camera for moving images. In this case, moving images with high resolution can be acquired in addition to still images.

Here, the digital still camera according to the present Embodiment 7 has been described for a case that the employed zoom lens system 1 is a zoom lens system according to Embodiments 1 to 6. However, in these zoom lens systems, the entire zooming range need not be used. That is, in accordance with a desired zooming range, a range where satisfactory optical performance is obtained may exclusively be used. Then, the zoom lens system may be used as one having a lower magnification than the zoom lens system described in Embodiments 1 to 6.

Further, Embodiment 7 has been described for a case that the zoom lens system is applied to a lens barrel of so-called barrel retraction construction. However, the present disclosure is not limited to this. For example, the zoom lens system may be applied to a lens barrel of so-called bending configuration where a prism having an internal reflective surface or a front surface reflective mirror is arranged at an arbitrary position within the first lens unit G1 or the like. Further, in Embodiment 7, the zoom lens system may be applied to a so-called sliding lens barrel in which a part of the lens units constituting the zoom lens system like the entirety of the second lens unit G2, the entirety of the third lens unit G3, or alternatively a part of the second lens unit G2, the third lens unit G3, the fourth lens unit G4, or the fifth lens unit G5 is caused to escape from the optical axis at the time of barrel retraction.

An imaging device comprising a zoom lens system according to Embodiments 1 to 6, and an image sensor such as a CCD or a CMOS may be applied to a camera for a mobile terminal device such as a smart-phone, a surveillance camera in a surveillance system, a Web camera, a vehicle-mounted camera or the like.

As described above, Embodiment 7 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

The following description is given for numerical examples in which the zoom lens system according to Embodiments 1 to 6 are implemented practically. In the numerical examples, the units of the length in the tables are all “mm”, while the units of the view angle are all “°”. Moreover, in the numerical examples, r is the radius of curvature, d is the axial distance, nd is the refractive index to the d-line, vd is the Abbe number to the d-line, and θgF is the partial dispersion ratio that is the ratio of a difference between a refractive index to the g-line and a refractive index to the F-line, to a difference between a refractive index to the F-line and a refractive index to the C-line. In the numerical examples, the surfaces marked with * are aspheric surfaces, and the aspheric surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, h is a height relative to the optical axis, κ is a conic constant, and An is a n-th order aspherical coefficient.

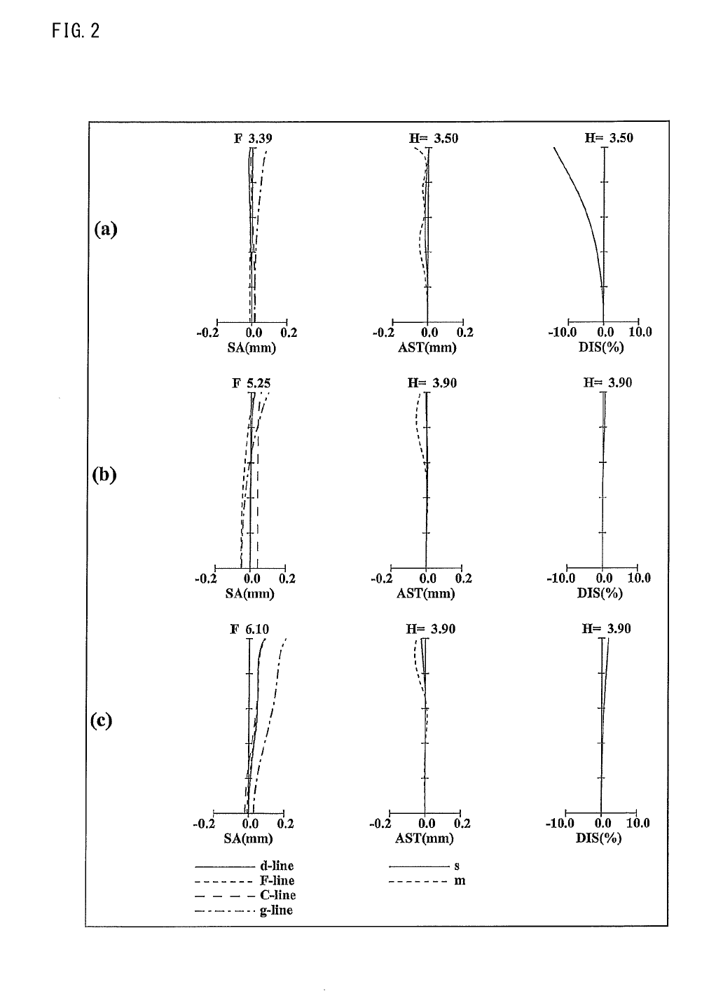

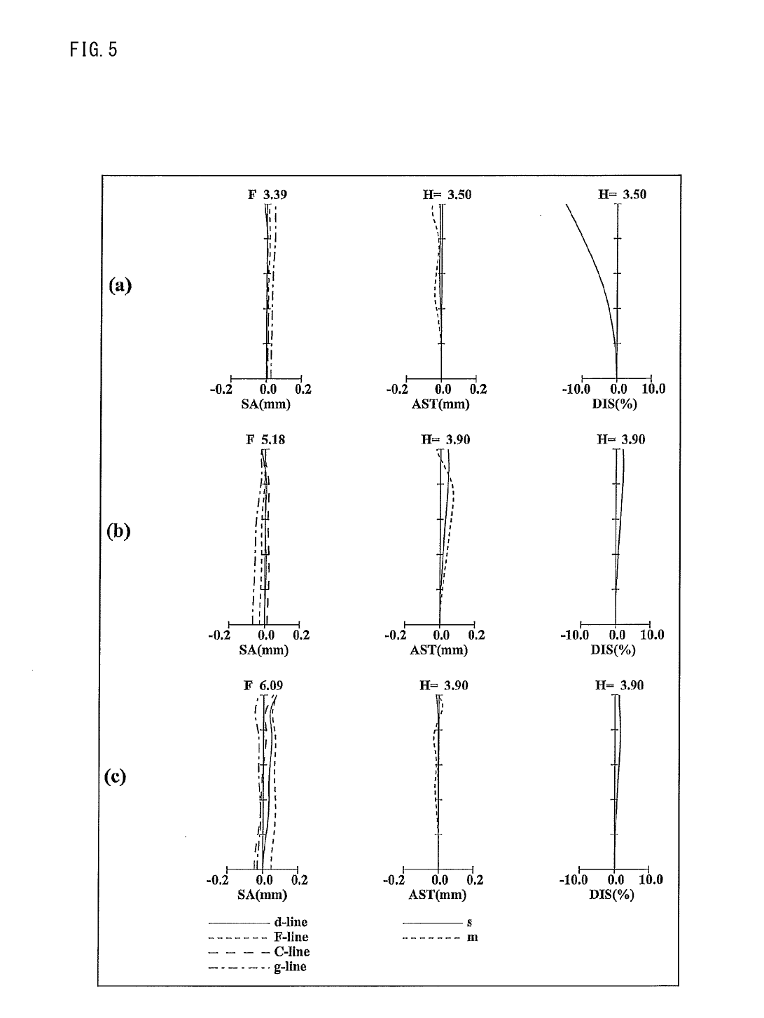

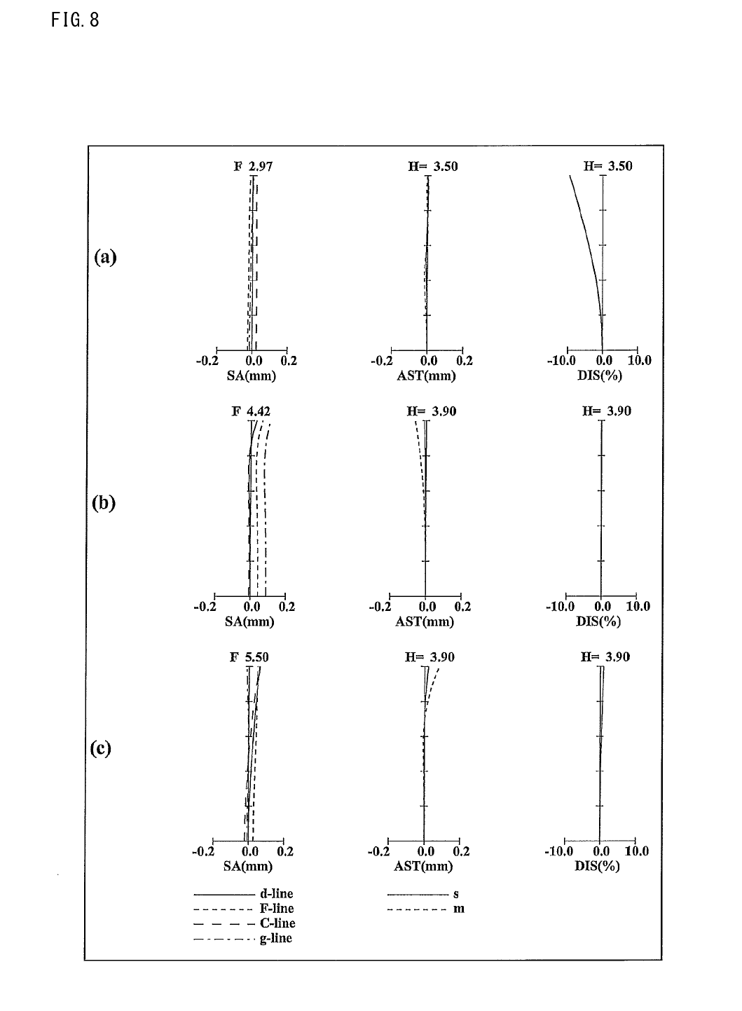

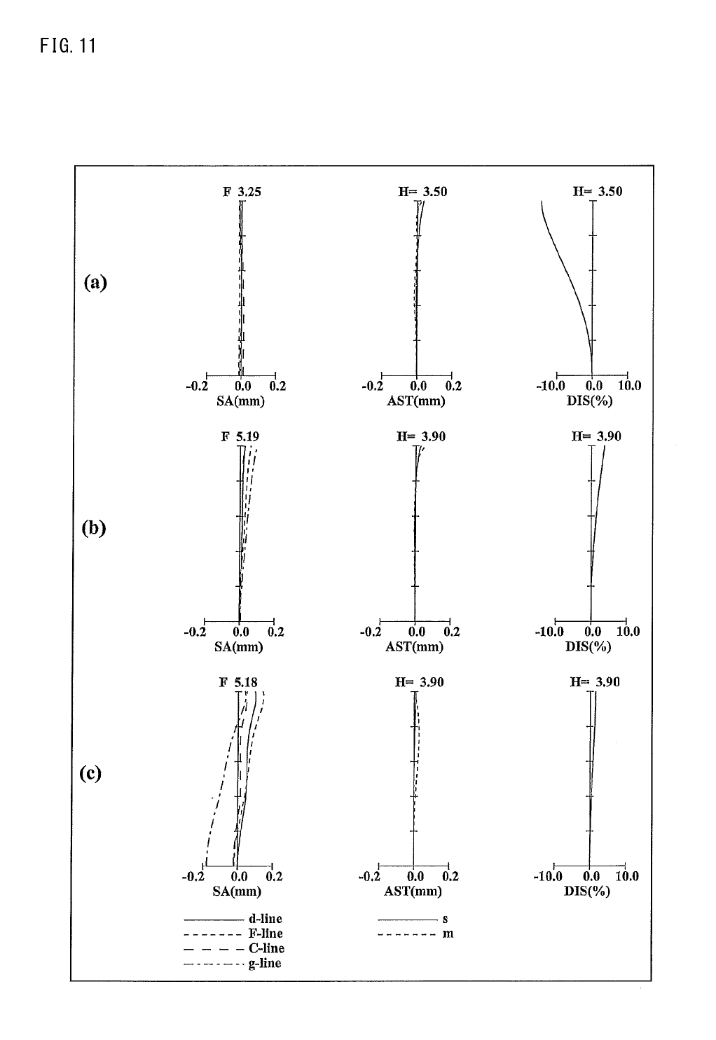

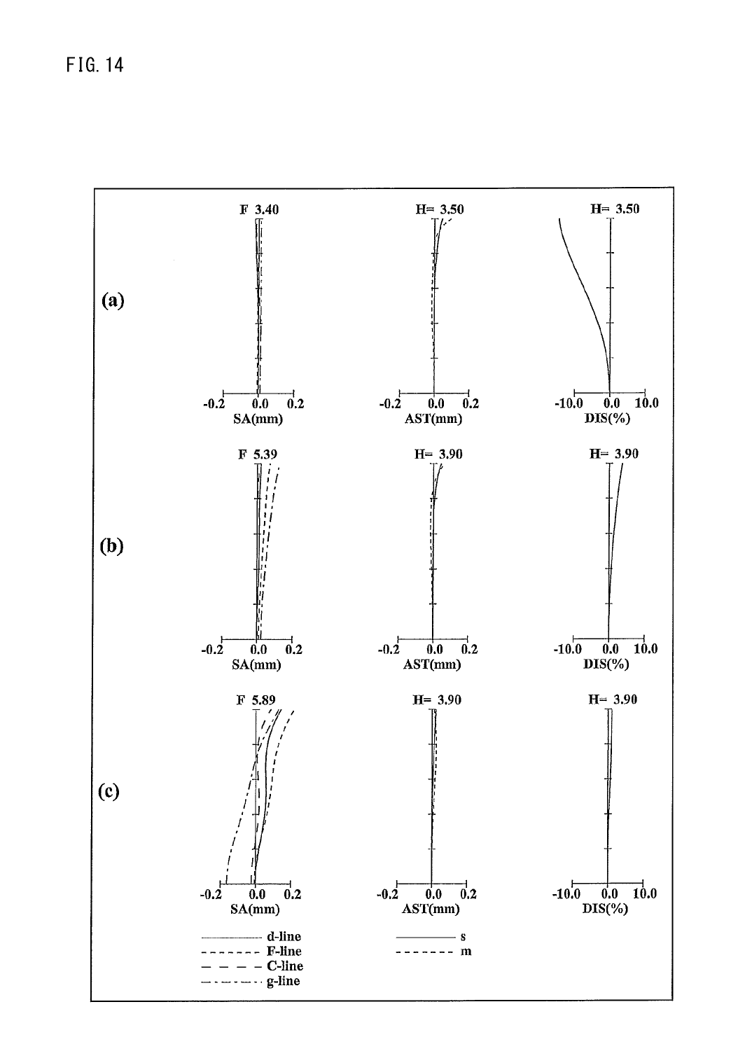

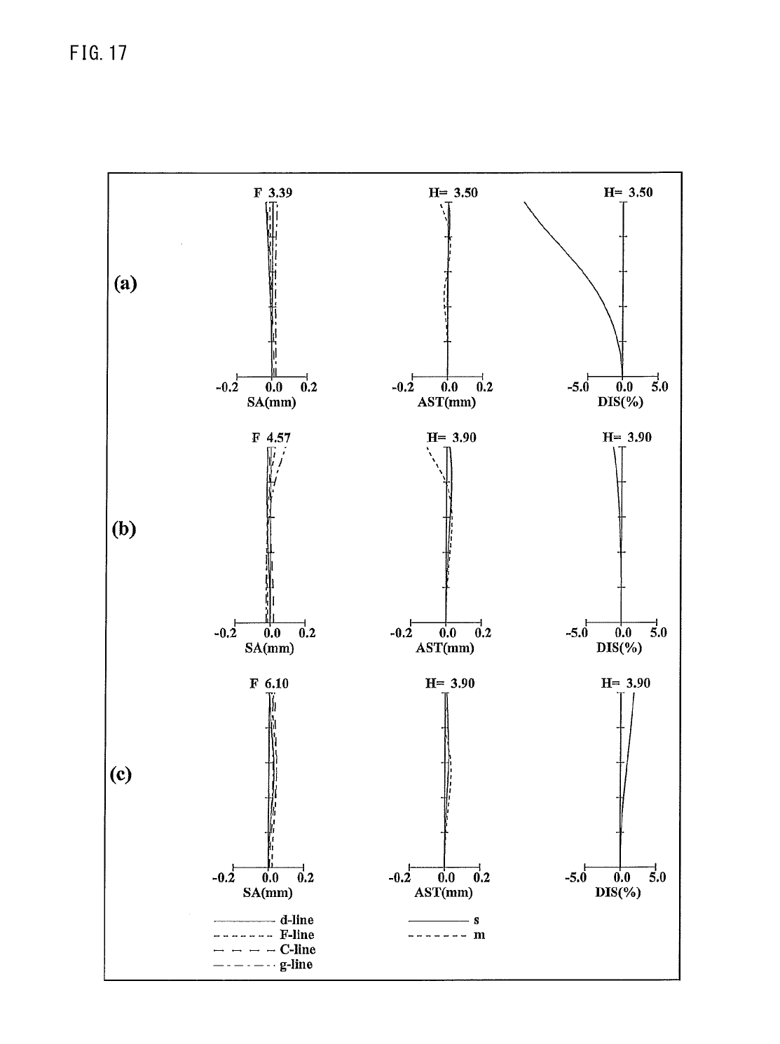

FIGS. 2, 5, 8, 11, 14, and 17 are longitudinal aberration diagrams of the zoom lens systems according to Numerical Examples 1 to 6, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line, the long dash line and the one-dot dash line indicate the characteristics to the d-line, the F-line, the C-line and the g-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

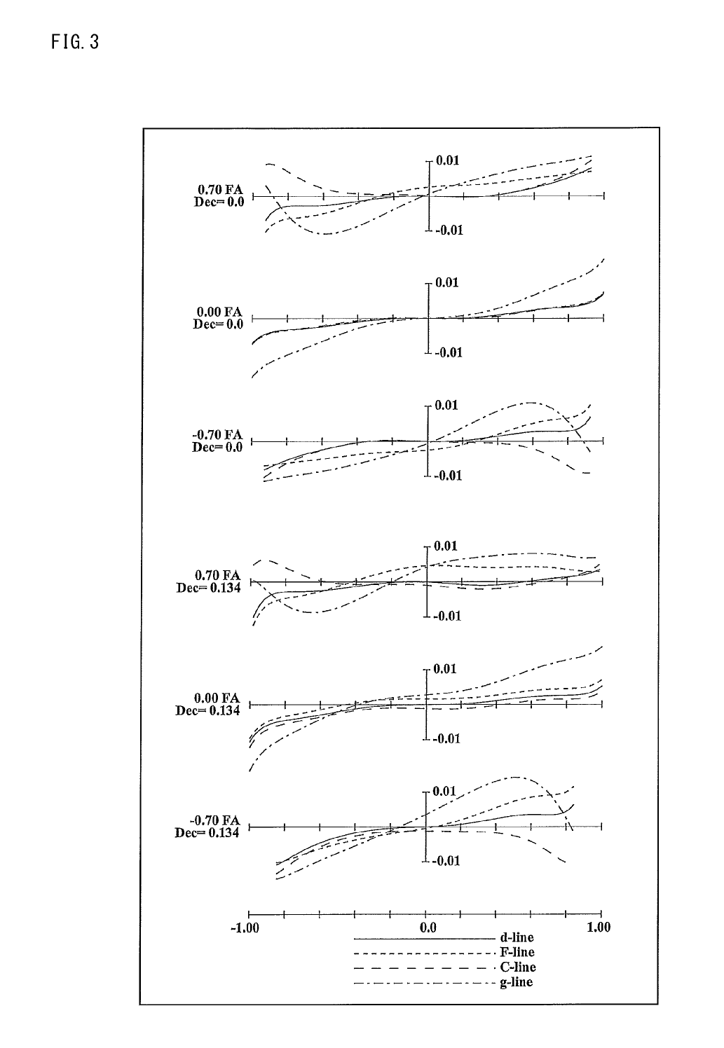

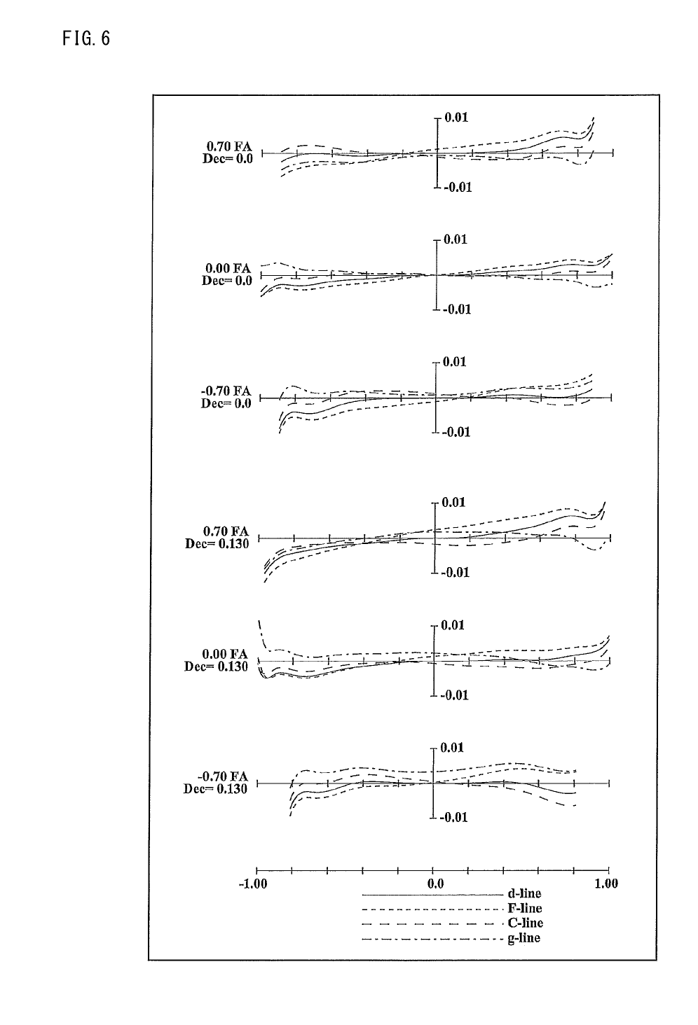

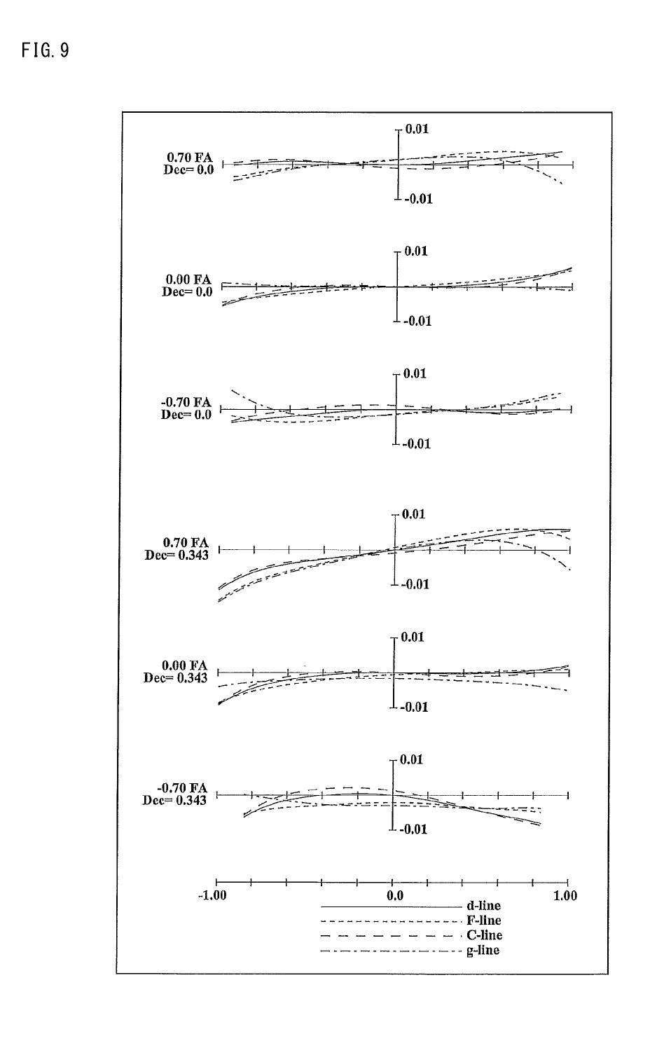

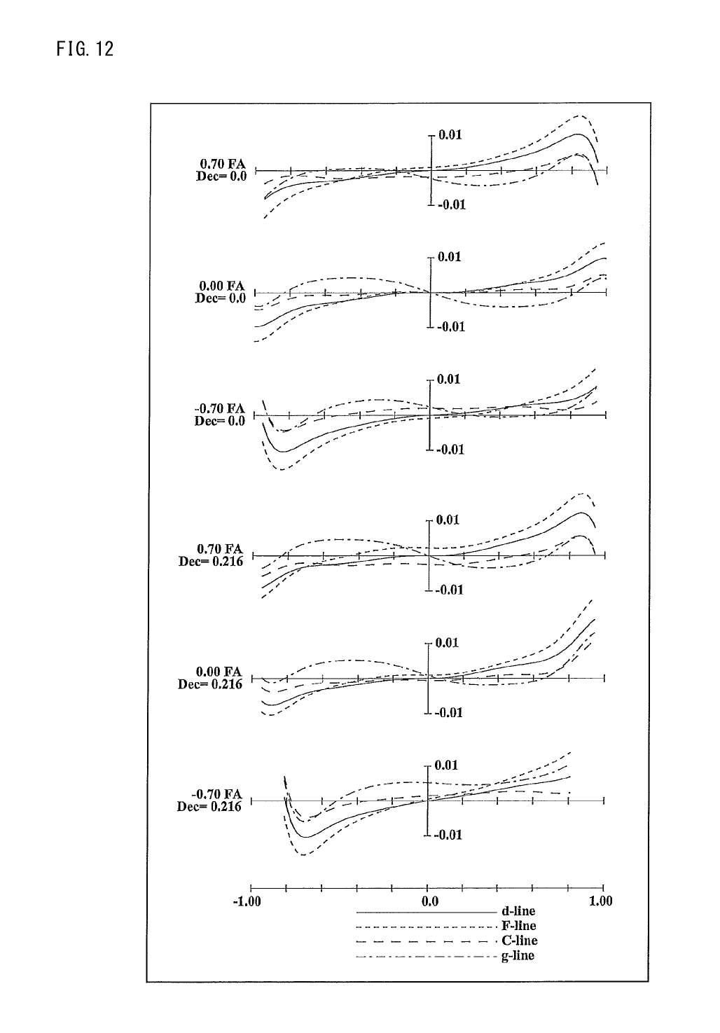

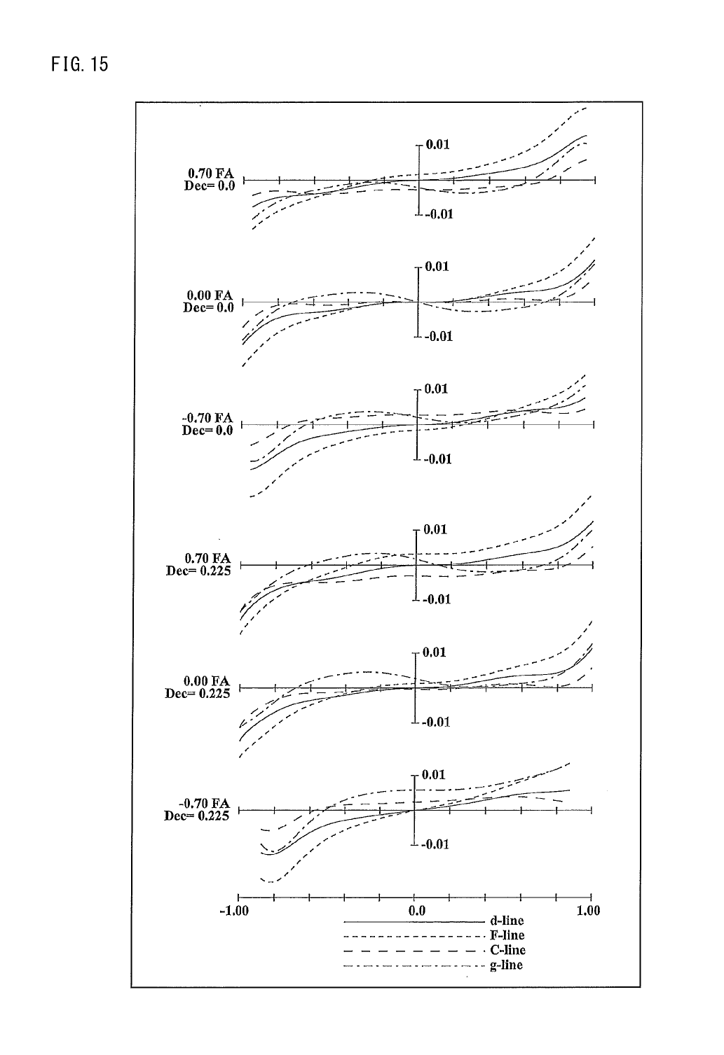

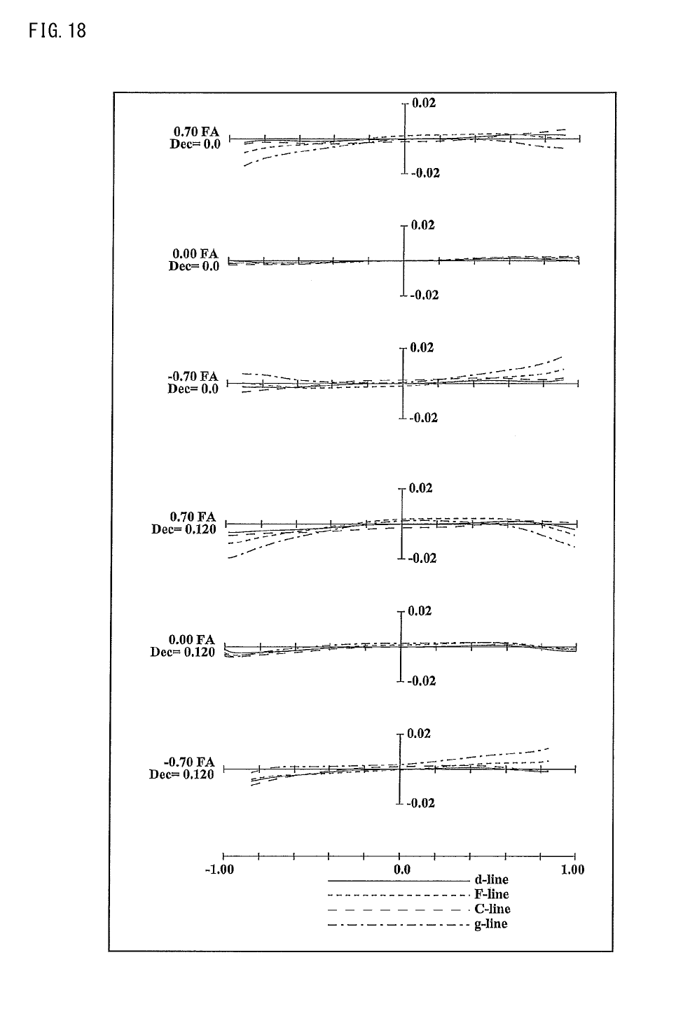

FIGS. 3, 6, 9, 12, 15, and 18 are lateral aberration diagrams of the zoom lens systems at a telephoto limit according to Numerical Examples 1 to 6, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the entirety of the third lens unit G3 (Numerical Examples 1 to 5) or the entirety of the fourth lens unit G4 (Numerical Example 6) is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line, the long dash line and the one-dot dash line indicate the characteristics to the d-line, the F-line, the C-line and the g-line, respectively. In each lateral aberration diagram, the meridional plane is adopted as the plane containing the optical axis of the first lens unit G1 and the optical axis of the third lens unit G3 (Numerical Examples 1 to 5), or the plane containing the optical axis of the first lens unit G1 and the optical axis of the fourth lens unit G4 (Numerical Example 6).

Here, in the zoom lens system according to each example, the amount of movement of the third lens unit G3 (Numerical Examples 1 to 5) or the fourth lens unit G4 (Numerical Example 6) in a direction perpendicular to the optical axis in an image blur compensation state at a telephoto limit is as follows.

| Numerical Example | Amount of movement (mm) |
|---|---|
| 1 | 0.134 |
| 2 | 0.130 |
| 3 | 0.343 |
| 4 | 0.216 |
| 5 | 0.225 |
| 6 | 0.120 |

Here, when the shooting distance is infinity, at a telephoto limit, the amount of image decentering in a case that the zoom lens system inclines by 0.3° is equal to the amount of image decentering in a case that the entirety of the third lens unit G3 (Numerical Examples 1 to 5) or the entirety of the fourth lens unit G4 (Numerical Example 6) displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.3° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd | θgF |
|---|---|---|---|---|---|
| Object surface | ∞ | | | | |
| 1* | 29.70650 | 0.10000 | 1.87806 | 13.1 | 0.751 |
| 2 | 24.56380 | 2.46240 | 1.62299 | 58.1 | |
| 3 | 568.86410 | 0.10000 | 1.59266 | 12.2 | 0.281 |
| 4* | 118.84240 | 0.15000 | | | |
| 5 | 22.06500 | 1.69490 | 1.80420 | 46.5 | |
| 6 | 51.65800 | Variable | | | |
| 7* | 36.60720 | 0.30000 | 1.80470 | 41.0 | |
| 8* | 4.73370 | 3.79350 | | | |
| 9 | −6.58260 | 0.30000 | 2.00100 | 29.1 | |
| 10 | −25.00380 | 0.10000 | | | |
| 11 | 65.93660 | 0.30000 | 1.94595 | 18.0 | |
| 12 | 65.93650 | 0.70000 | 1.75998 | 12.9 | 0.635 |
| 13* | −13.55230 | Variable | | | |
| 14(Diaphragm) | ∞ | 0.30000 | | | |
| 15* | 4.77550 | 2.18930 | 1.58332 | 59.1 | |
| 16* | 3671.38070 | 1.03840 | | | |
| 17 | 36.75970 | 1.07230 | 1.48749 | 70.4 | |
| 18 | −11.00890 | 0.40000 | 1.82115 | 24.1 | |
| 19* | 51.28740 | Variable | | | |
| 20 | 25.26620 | 0.50000 | 2.00100 | 29.1 | |
| 21 | 13.17010 | Variable | | | |
| 22* | 12.71540 | 1.59540 | 1.58332 | 59.1 | |
| 23* | −500.00000 | Variable | | | |
| 24 | ∞ | 0.80000 | 1.51680 | 64.2 | |
| 25 | ∞ | (BF) | | | |
| Image surface | ∞ | | | | |

TABLE 2
(Aspherical data)

Surface No. 1
K = 0.00000E+00, A4 = −8.81318E−06, A6 = 1.36962E−07,
A8 = −2.22579E−10 A10 = −8.16614E−12, A12 = 6.48512E−14
Surface No. 4
K = 0.00000E+00, A4 = −1.39198E−05, A6 = 2.85553E−07,
A8 = −1.26504E−09 A10 = −8.24286E−12, A12 = 1.01311E−13
Surface No. 7
K = 0.00000E+00, A4 = 1.16079E−04, A6 = −8.49496E−06,
A8 = 2.75168E−08 A10 = 2.84110E−09, A12 = 0.00000E+00
Surface No. 8
K = 0.00000E+00, A4 = −1.17693E−04, A6 = −5.25509E−05,
A8 = 4.69214E−06 A10 = −2.99414E−07, A12 = 0.00000E+00
Surface No. 13
K = 0.00000E+00, A4 = 5.96545E−06, A6 = 2.95922E−07,
A8 = −5.14738E−07 A10 = 8.84119E−08, A12 = −2.51908E−09
Surface No. 15
K = 0.00000E+00, A4 = −9.42499E−05, A6 = −9.72250E−06,
A8 = 4.33501E−07 A10 = 6.56678E−08, A12 = 0.00000E+00
Surface No. 16
K = 0.00000E+00, A4 = −1.06097E−05, A6 = −2.92325E−05,
A8 = 3.91073E−06 A10 = 0.00000E+00, A12 = 0.00000E+00
Surface No. 19
K = 0.00000E+00, A4 = 2.13809E−03, A6 = 1.20859E−04,
A8 = −2.39553E−06 A10 = 1.05580E−06, A12 = 0.00000E+00
Surface No. 22
K = 0.00000E+00, A4 = 2.01115E−04, A6 = −2.48171E−05,
A8 = 3.57944E−07 A10 = 9.85878E−08, A12 = −4.00162E−09
Surface No. 23
K = 0.00000E+00, A4 = 8.95379E−05, A6 = −7.95509E−06,
A8 = −2.21602E−06 A10 = 2.52415E−07, A12 = −7.34174E−09

TABLE 3
(Various data)
Zooming ratio 15.15867

| | Wide-angle | Middle | Telephoto |
|---|---|---|---|
| | limit | position | limit |
| Focal length | 4.6502 | 18.6022 | 70.4907 |
| F-number | 3.39057 | 5.24652 | 6.10105 |
| View angle | 41.3087 | 11.7777 | 3.1090 |
| Image height | 3.5000 | 3.9000 | 3.9000 |
| Overall length | 46.1304 | 51.8230 | 55.9931 |
| of lens system | | | |
| BF | 0.52208 | 0.51861 | 0.47302 |
| d6 | 0.3001 | 9.2434 | 17.2269 |
| d13 | 15.6948 | 5.3343 | 0.5527 |
| d19 | 1.0301 | 8.1434 | 9.1572 |
| d21 | 5.8489 | 2.8261 | 7.8205 |
| d23 | 4.8382 | 7.8610 | 2.8666 |
| Entrance pupil | 10.1397 | 34.3165 | 110.3074 |
| position | | | |
| Exit pupil | −24.1907 | −31.8980 | −76.3357 |
| position | | | |
| Front principal | 13.9149 | 42.2439 | 116.1057 |
| points position | | | |
| Back principal | 41.4802 | 33.2208 | −14.4976 |
| points position | | | |

Zoom lens unit data

| Lens | Initial | Focal |
|---|---|---|
| unit | surface No. | length |
| 1 | 1 | 28.40638 |
| 2 | 7 | −5.02475 |
| 3 | 14 | 9.66052 |
| 4 | 20 | −28.06235 |
| 5 | 22 | 21.28212 |

### Numerical Example 2

The zoom lens system of Numerical Example 2 corresponds to Embodiment 2 shown in FIG. 4. Table 4 shows the surface data of the zoom lens system of Numerical Example 2. Table 5 shows the aspherical data. Table 6 shows the various data.

TABLE 4
(Surface data)

| Surface number | r | d | nd | vd | θgF |
|---|---|---|---|---|---|
| Object surface | ∞ | | | | |
| 1 | 42.38020 | 0.75000 | 1.84666 | 23.8 | |
| 2 | 28.20350 | 3.19860 | 1.49700 | 81.6 | |
| 3 | −120.85030 | 0.10000 | 1.51632 | 27.2 | 0.368 |
| 4* | −934.13670 | 0.15000 | | | |
| 5 | 25.41120 | 1.99330 | 1.72916 | 54.7 | |
| 6 | 76.79770 | Variable | | | |
| 7* | 63.49090 | 0.50000 | 1.88202 | 37.2 | |
| 8* | 5.34120 | 3.43580 | | | |
| 9 | −7.39600 | 0.30000 | 1.72916 | 54.7 | |
| 10 | −73.31830 | 0.16940 | | | |
| 11 | 33.81680 | 1.19740 | 1.94595 | 18.0 | |
| 12 | −24.77490 | Variable | | | |
| 13(Diaphragm) | ∞ | 0.30000 | | | |
| 14* | 6.27400 | 2.02950 | 1.58332 | 59.1 | |
| 15* | −19.50330 | 0.41250 | | | |
| 16 | 9.40980 | 1.29290 | 1.51680 | 64.2 | |
| 17 | −54.86340 | 0.30000 | 1.90366 | 31.3 | |
| 18 | 5.44290 | 0.40440 | | | |
| 19 | 13.10020 | 2.00000 | 1.56341 | 51.8 | 0.617 |
| 20 | −13.38140 | Variable | | | |
| 21 | 71.63730 | 0.50000 | 1.88300 | 40.8 | |
| 22 | 9.51570 | Variable | | | |
| 23* | 9.16580 | 2.14530 | 1.52996 | 55.8 | |
| 24* | −68.38470 | 3.00520 | | | |
| 25 | ∞ | 0.80000 | 1.51680 | 64.2 | |
| 26 | ∞ | (BF) | | | |
| Image surface | ∞ | | | | |

TABLE 5
(Aspherical data)

Surface No. 4
K = 0.00000E+00, A4 = 1.32389E−08, A6 = 4.41971E−09,
A8 = −3.63943E−11 A10 = 1.07017E−13, A12 = 0.00000E+00
Surface No. 7
K = 0.00000E+00, A4 = −1.31117E−04, A6 = 1.36489E−05,
A8 = −2.74551E−07 A10 = 1.06774E−09, A12 = 0.00000E+00
Surface No. 8
K = 0.00000E+00, A4 = −2.82842E−04, A6 = −7.36196E−06,
A8 = 2.11582E−06 A10 = −2.63569E−08, A12 = 0.00000E+00
Surf ace No. 14
K = 0.00000E+00, A4 = −6.70273E−04, A6 = −1.83958E−05,
A8 = −5.37613E−06 A10 = 5.45549E−07, A12 = −4.61749E−08
Surface No. 15
K = 0.00000E+00, A4 = −6.62305E−05, A6 = −3.51598E−05,
A8 = −1.06720E−06 A10 = −4.39089E−08, A12 = −1.48226E−08
Surface No. 23
K = 0.00000E+00, A4 = 2.56862E−05, A6 = 1.90183E−05,
A8 = −2.60216E−06 A10 = 1.57043E−07, A12 = −5.24384E−09
Surface No. 24
K = 0.00000E+00, A4 = 2.44391E−04, A6 = −1.14093E−05,
A8 = 6.63655E−07 A10 = −6.77964E−08, A12 = 0.00000E+00

TABLE 6
(Various data)
Zooming ratio 18.39413

| | Wide-angle | Middle | Telephoto |
|---|---|---|---|
| | limit | position | limit |
| Focal length | 4.6547 | 19.9902 | 85.6192 |
| F-number | 3.39391 | 5.17510 | 6.09207 |
| View angle | 41.4478 | 10.8352 | 2.5777 |
| Image height | 3.5000 | 3.9000 | 3.9000 |
| Overall length | 50.0856 | 57.8260 | 69.0645 |
| of lens system | | | |
| BF | 0.53837 | 0.55127 | 0.55335 |
| d6 | 0.3000 | 12.8221 | 23.5721 |
| d12 | 17.7000 | 5.7907 | 0.7777 |
| d20 | 4.5629 | 10.5422 | 8.7641 |
| d22 | 2.0000 | 3.1354 | 10.4130 |
| Entrance pupil | 11.3154 | 42.4824 | 142.4477 |
| position | | | |
| Exit pupil | −19.9148 | −35.3447 | 146.0949 |
| position | | | |
| Front principal | 14.9108 | 51.3402 | 278.4351 |
| points position | | | |
| Back principal | 45.4309 | 37.8358 | −16.5547 |
| points position | | | |

Zoom lens unit data

| Lens | Initial | Focal |
|---|---|---|
| unit | surface No. | length |
| 1 | 1 | 36.82740 |
| 2 | 7 | −5.81682 |
| 3 | 13 | 9.96228 |
| 4 | 21 | −12.47438 |
| 5 | 23 | 15.39867 |

### Numerical Example 3

The zoom lens system of Numerical Example 3 corresponds to Embodiment 3 shown in FIG. 7. Table 7 shows the surface data of the zoom lens system of Numerical Example 3. Table 8 shows the aspherical data. Table 9 shows the various data.

TABLE 7
(Surface data)

| Surface number | r | d | nd | vd | θgF |
|---|---|---|---|---|---|
| Object surface | ∞ | | | | |
| 1 | 134.05430 | 1.25000 | 1.90366 | 31.3 | |
| 2 | 58.58310 | 3.92650 | 1.48749 | 70.4 | |
| 3 | −345.87030 | 0.15000 | | | |
| 4 | 62.64410 | 3.17220 | 1.49700 | 81.6 | |
| 5 | 928.61370 | 0.15000 | | | |
| 6 | 35.85380 | 3.48220 | 1.49700 | 81.6 | |
| 7 | 96.24640 | 0.10000 | 1.73531 | 7.3 | 0.249 |
| 8* | 92.87380 | Variable | | | |
| 9* | 5000.00000 | 1.20000 | 1.80470 | 41.0 | |
| 10* | 6.92920 | 4.10810 | | | |
| 11 | −28.66730 | 0.70000 | 1.81600 | 46.6 | |
| 12 | 25.09380 | 1.19090 | 1.87806 | 13.1 | 0.751 |
| 13 | 42.31840 | 0.17220 | | | |
| 14 | 16.85920 | 1.60990 | 1.92286 | 20.9 | |
| 15 | 64.60840 | Variable | | | |
| 16(Diaphragm) | ∞ | 1.20000 | | | |
| 17* | 10.57080 | 1.68880 | 1.58332 | 59.1 | |
| 18 | −136.06150 | 2.50300 | | | |
| 19 | 13.57870 | 1.92630 | 1.59270 | 35.4 | |
| 20 | 129.00090 | 0.70000 | 1.80518 | 25.5 | |
| 21 | 8.63070 | 0.55020 | | | |
| 22 | 36.43090 | 1.22270 | 1.49700 | 81.6 | |
| 23 | −27.97960 | Variable | | | |
| 24 | 18.02480 | 1.91230 | 1.60625 | 63.7 | |
| 25 | −36.82450 | 0.60000 | 1.90366 | 31.3 | |
| 26 | −143.90830 | Variable | | | |
| 27 | ∞ | 0.80000 | 1.51680 | 64.2 | |
| 28 | ∞ | (BF) | | | |
| Image surface | ∞ | | | | |

TABLE 8
(Aspherical data)

Surface No. 8
K = 0.00000E+00, A4 = −5.34727E−08, A6 = −2.34868E−11,
A8 = −5.18677E−14 A10 = 7.86378E−16, A12 = −1.71401E−18,
A14 = 0.00000E+00, A16 = 0.00000E+00
Surface No. 9
K = 0.00000E+00, A4 = 1.23682E−04, A6 = −3.41947E−06,
A8 = 5.51356E−08 A10 = −5.65687E−10, A12 = 2.48801E−12,
A14 = 0.00000E+00, A16 = 0.00000E+00
Surface No. 10
K = 2.59626E−02, A4 = 6.18363E−05, A6 = −3.43193E−06,
A8 = −6.08297E−08 A10 = 4.19879E−09, A12 = −1.53825E−10,
A14 = 0.00000E+00, A16 = 0.00000E+00
Surface No. 17
K = 0.00000E+00, A4 = −1.05465E−04, A6 = −1.72913E−07,
A8 = −7.24537E−09 A10 = −9.19758E−10, A12 = 4.63596E−11,
A14 = −1.08341E−13, A16 = −2.03834E−14

TABLE 9
(Various data)
Zooming ratio 22.92464

| | Wide-angle | Middle | Telephoto |
|---|---|---|---|
| | limit | position | limit |
| Focal length | 4.6381 | 22.1363 | 106.3269 |
| F-number | 2.97215 | 4.42236 | 5.50134 |
| View angle | 39.8815 | 10.0091 | 2.0791 |
| Image height | 3.5000 | 3.9000 | 3.9000 |
| Overall length | 83.1528 | 98.0556 | 110.1625 |
| of lens system | | | |
| BF | 0.92018 | 1.11389 | 1.14454 |
| d8 | 0.5323 | 18.1321 | 40.7197 |
| d15 | 32.4415 | 7.7292 | 2.0400 |
| d23 | 7.8164 | 20.0466 | 23.9430 |
| d26 | 7.1271 | 16.7185 | 8.0000 |
| Entrance pupil | 19.4599 | 58.7653 | 334.3249 |
| position | | | |
| Exit pupil | −37.5124 | −218.4226 | −2656.5071 |
| position | | | |
| Front principal | 23.5382 | 78.6696 | 436.3980 |
| points position | | | |
| Back principal | 78.5147 | 75.9193 | 3.8356 |
| points position | | | |

Zoom lens unit data

| Lens | Initial | Focal |
|---|---|---|
| unit | surface No. | length |
| 1 | 1 | 58.95569 |
| 2 | 9 | −8.20972 |
| 3 | 16 | 18.53893 |
| 4 | 24 | 31.38930 |

### Numerical Example 4

The zoom lens system of Numerical Example 4 corresponds to Embodiment 4 shown in FIG. 10. Table 10 shows the surface data of the zoom lens system of Numerical Example 4. Table 11 shows the aspherical data. Table 12 shows the various data.

TABLE 10
(Surface data)

| Surface number | r | d | nd | vd | θgF |
|---|---|---|---|---|---|
| Object surface | ∞ | | | | |
| 1 | 76.01860 | 1.25000 | 1.90366 | 31.3 | |
| 2 | 36.48280 | 4.69020 | 1.49700 | 81.6 | |
| 3 | 446.15950 | 0.15000 | | | |
| 4 | 39.63210 | 3.78650 | 1.59282 | 68.6 | |
| 5 | 111.00100 | 0.15000 | | | |
| 6 | 47.81470 | 3.03350 | 1.72916 | 54.7 | |
| 7 | 201.43900 | 0.10000 | 1.59266 | 12.2 | 0.281 |
| 8 | 162.04320 | Variable | | | |
| 9* | −99.67690 | 0.50000 | 1.84973 | 40.6 | |
| 10* | 13.85340 | 3.77750 | | | |
| 11 | −19.14060 | 0.70000 | 1.88300 | 40.8 | |
| 12 | 33.32610 | 0.40060 | | | |
| 13 | 25.35260 | 2.46450 | 2.00272 | 19.3 | |
| 14 | −21.38770 | 0.33610 | | | |
| 15 | −17.27840 | 0.70000 | 1.88300 | 40.8 | |
| 16 | 71.41870 | Variable | | | |
| 17(Diaphragm) | ∞ | 0.30000 | | | |
| 18* | 7.57730 | 1.95620 | 1.66547 | 55.2 | |
| 19* | 17.06320 | 0.54190 | | | |
| 20 | 11.58000 | 1.66030 | 1.49700 | 81.6 | |
| 21 | −41.30770 | 0.42260 | | | |
| 22 | 12.36400 | 3.15230 | 1.49700 | 81.6 | |
| 23 | −5.46160 | 0.40000 | 1.90366 | 31.3 | |
| 24 | 9.09110 | 1.76050 | | | |
| 25 | 16.06150 | 1.34770 | 1.80610 | 33.3 | |
| 26 | −15.17300 | Variable | | | |
| 27* | −203.25460 | 0.40000 | 1.52500 | 70.4 | |
| 28* | 5.82380 | Variable | | | |
| 29* | 58.06480 | 2.29070 | 1.56341 | 51.8 | 0.617 |
| 30* | −8.98050 | Variable | | | |
| 31 | ∞ | 0.80000 | 1.51680 | 64.2 | |
| 32 | ∞ | (BF) | | | |
| Image surface | ∞ | | | | |

TABLE 11
(Aspherical data)

Surface No. 9
K = 0.00000E+00, A4 = −2.74460E−05, A6 = 3.62641E−06,
A8 = −5.63672E−08 A10 = 4.45930E−10, A12 = −1.49485E−12
Surface No. 10
K = −6.75603E−01, A4 = −6.48477E−06, A6 = 2.72516E−06,
A8 = 5.93486E−08 A10 = −1.71182E−09, A12 = 1.96444E−11
Surface No. 18
K = 0.00000E+00, A4 = 2.17801E−04, A6 = 3.75171E−06,
A8 = 6.95030E−08 A10 = 6.98376E−09, A12 = 0.00000E+00
Surface No. 19
K = 0.00000E+00, A4 = 4.31852E−04, A6 = 2.03930E−06,
A8 = 3.10343E−07 A10 = 0.00000E+00, A12 = 0.00000E+00
Surface No. 27
K = 0.00000E+00, A4 = 8.40146E−04, A6 = −9.49865E−05,
A8 = 3.95053E−06 A10 = −5.67656E−08, A12 = 0.00000E+00
Surface No. 28
K = 0.00000E+00, A4 = 1.04781E−03, A6 = −7.21402E−05,
A8 = 1.75965E−06 A10 = 0.00000E+00, A12 = 0.00000E+00
Surface No. 29
K = 0.00000E+00, A4 = −2.97914E−05, A6 = −1.35594E−06,
A8 = 6.25049E−07 A10 = 0.00000E+00, A12 = 0.00000E+00
Surface No. 30
K = 0.00000E+00, A4 = 2.90876E−04, A6 = −7.76734E−06,
A8 = 3.96245E−07 A10 = 1.03549E−08, A12 = 0.00000E+00

TABLE 12
(Various data)
Zooming ratio 29.05322

| | Wide-angle | Middle | Telephoto |
|---|---|---|---|
| | limit | position | limit |
| Focal length | 4.4196 | 23.8341 | 128.4037 |
| F-number | 3.25179 | 5.19257 | 5.17514 |
| View angle | 42.8228 | 8.9659 | 1.7146 |
| Image height | 3.5000 | 3.9000 | 3.9000 |
| Overall length | 78.7137 | 85.5517 | 87.3218 |
| of lens system | | | |
| BF | 0.96385 | 0.96241 | 0.94169 |
| d8 | 0.3346 | 20.9846 | 32.4178 |
| d16 | 32.9046 | 13.4289 | 0.7477 |
| d26 | 1.2824 | 4.5970 | 4.9031 |
| d28 | 2.5236 | 6.4821 | 10.4904 |
| d30 | 3.6335 | 2.0256 | 0.7500 |
| Entrance pupil | 21.2153 | 97.5618 | 259.1234 |
| position | | | |
| Exit pupil | −37.1146 | 560.2721 | 56.7915 |
| position | | | |
| Front principal | 25.1220 | 122.4116 | 682.7385 |
| points position | | | |
| Back principal | 74.2940 | 61.7176 | −41.0819 |
| points position | | | |

Zoom lens unit data

| Lens | Initial | Focal |
|---|---|---|
| unit | surface No. | length |
| 1 | 1 | 49.93879 |
| 2 | 9 | −7.40008 |
| 3 | 17 | 11.86586 |
| 4 | 27 | −10.77686 |
| 5 | 29 | 13.97659 |

### Numerical Example 5

The zoom lens system of Numerical Example 5 corresponds to Embodiment 5 shown in FIG. 13. Table 13 shows the surface data of the zoom lens system of Numerical Example 5. Table 14 shows the aspherical data. Table 15 shows the various data.

TABLE 13
(Surface data)

| Surface number | r | d | nd | vd | θgF |
|---|---|---|---|---|---|
| Object surface | ∞ | | | | |
| 1 | 79.87440 | 1.25000 | 1.90366 | 31.3 | |
| 2 | 37.29730 | 4.99400 | 1.49700 | 81.6 | |
| 3 | 612.59810 | 0.15000 | | | |
| 4 | 40.18970 | 4.09900 | 1.59282 | 68.6 | |
| 5 | 119.10730 | 0.15000 | | | |
| 6 | 47.92730 | 3.19090 | 1.72916 | 54.7 | |
| 7 | 190.51870 | 0.10000 | 1.59266 | 12.2 | 0.281 |
| 8 | 157.88680 | Variable | | | |
| 9* | −102.10760 | 0.50000 | 1.84973 | 40.6 | |
| 10* | 12.79970 | 4.11210 | | | |
| 11 | −17.98280 | 0.70000 | 1.88300 | 40.8 | |
| 12 | 46.38300 | 0.23950 | | | |
| 13 | 26.15370 | 2.53620 | 2.00272 | 19.3 | |
| 14 | −20.76930 | 0.28550 | | | |
| 15 | −17.74290 | 0.70000 | 1.88300 | 40.8 | |
| 16 | 64.94080 | Variable | | | |
| 17(Diaphragm) | ∞ | 0.30000 | | | |
| 18* | 7.46880 | 1.94280 | 1.66547 | 55.2 | |
| 19* | 16.50910 | 0.48810 | | | |
| 20 | 11.08520 | 1.53370 | 1.49700 | 81.6 | |
| 21 | −49.50080 | 0.46280 | | | |
| 22 | 12.99500 | 3.10410 | 1.49700 | 81.6 | |
| 23 | −5.30970 | 0.40000 | 1.90366 | 31.3 | |
| 24 | 8.46730 | 1.50860 | | | |
| 25 | 14.08340 | 1.44030 | 1.80610 | 33.3 | |
| 26 | −14.44130 | Variable | | | |
| 27* | −67.54320 | 0.40000 | 1.52500 | 70.4 | |
| 28* | 6.01400 | Variable | | | |
| 29* | 37.53130 | 2.19240 | 1.56341 | 51.8 | 0.617 |
| 30* | −10.23040 | Variable | | | |
| 31 | ∞ | 0.80000 | 1.51680 | 64.2 | |
| 32 | ∞ | (BF) | | | |
| Image surface | ∞ | | | | |

TABLE 14
(Aspherical data)

Surface No. 9
K = 0.00000E+00, A4 = −2.31959E−05, A6 = 3.59038E−06,
A8 = −5.70697E−08 A10 = 4.42272E−10, A12 = −1.44436E−12
Surface No. 10
K = −5.24645E−01, A4 = 2.17728E−06, A6 = 2.75617E−06,
A8 = 6.53795E−08 A10 = −1.73913E−09, A12 = 1.96444E−11
Surface No. 18
K = 0.00000E+00, A4 = 2.21368E−04, A6 = 2.99781E−06,
A8 = 9.71982E−08 A10 = 5.99213E−09, A12 = 0.00000E+00
Surface No. 19
K = 0.00000E+00, A4 = 4.23871E−04, A6 = 8.03867E−07,
A8 = 2.86598E−07 A10 = 0.00000E+00, A12 = 0.00000E+00
Surface No. 27
K = 0.00000E+00, A4 = 9.27380E−04, A6 = −9.10192E−05,
A8 = 4.32577E−06 A10 = −6.73519E−08, A12 = 0.00000E+00
Surface No. 28
K = 0.00000E+00, A4 = 9.60767E−04, A6 = −7.27381E−05,
A8 = 2.42562E−06 A10 = 0.00000E+00, A12 = 0.00000E+00
Surface No. 29
K = 0.00000E+00, A4 = −4.83077E−05, A6 = −3.60910E−06,
A8 = 4.17679E−07 A10 = 0.00000E+00, A12 = 0.00000E+00
Surface No. 30
K = 0.00000E+00, A4 = 2.29305E−04, A6 = −9.52975E−06,
A8 = 4.61233E−07 A10 = 9.85577E−10, A12 = 0.00000E+00

TABLE 15
(Various data)
Zooming ratio 34.33482

| | Wide-angle | Middle | Telephoto |
|---|---|---|---|
| | limit | position | limit |
| Focal length | 4.3974 | 26.1503 | 150.9852 |
| F-number | 3.40359 | 5.39377 | 5.89240 |
| View angle | 42.9587 | 8.1825 | 1.4646 |
| Image height | 3.5000 | 3.9000 | 3.9000 |
| Overall length | 82.4376 | 89.0384 | 91.1565 |
| of lens system | | | |
| BF | 0.98022 | 0.95964 | 0.95334 |
| d8 | 0.3484 | 22.3873 | 32.6911 |
| d16 | 35.0212 | 14.1102 | 0.7564 |
| d26 | 1.1939 | 4.4862 | 4.4097 |
| d28 | 3.3065 | 7.3343 | 14.0149 |
| d30 | 4.0074 | 2.1808 | 0.7511 |
| Entrance pupil | 21.8240 | 111.8670 | 275.0833 |
| position | | | |
| Exit pupil | −39.1242 | 702.8651 | 43.1125 |
| position | | | |
| Front principal | 25.7393 | 138.9915 | 966.7937 |
| points position | | | |
| Back principal | 78.0402 | 62.8881 | −59.8286 |
| points position | | | |

Zoom lens unit data

| Lens | Initial | Focal |
|---|---|---|
| unit | surface No. | length |
| 1 | 1 | 50.01099 |
| 2 | 9 | −7.35865 |
| 3 | 17 | 11.85311 |
| 4 | 27 | −10.49901 |
| 5 | 29 | 14.50862 |

### Numerical Example 6

The zoom lens system of Numerical Example 6 corresponds to Embodiment 6 shown in FIG. 16. Table 16 shows the surface data of the zoom lens system of Numerical Example 6. Table 17 shows the aspherical data. Table 18 shows the various data.

TABLE 16
(Surface data)

| Surface number | r | d | nd | vd | θgF |
|---|---|---|---|---|---|
| Object surface | ∞ | | | | |
| 1 | 38.50390 | 0.75000 | 1.84666 | 23.8 | |
| 2 | 25.21440 | 0.01000 | 1.56732 | 42.8 | |
| 3 | 25.21440 | 3.67880 | 1.49700 | 81.6 | |
| 4 | −2037.57780 | 0.10000 | 1.59266 | 12.2 | 0.281 |
| 5 | 2105.03700 | 0.15000 | | | |
| 6 | 27.03950 | 1.45040 | 1.75500 | 52.3 | |
| 7 | 60.51940 | Variable | | | |
| 8 | 100.00000 | 2.00000 | 1.48749 | 70.4 | |
| 9 | 250.00000 | Variable | | | |
| 10* | 784.75380 | 0.30000 | 1.85135 | 40.1 | |
| 11* | 5.43810 | 3.29980 | | | |
| 12 | −9.20010 | 0.30000 | 1.75500 | 52.3 | |
| 13 | 1326.58880 | 0.15420 | | | |
| 14 | 24.34520 | 1.23620 | 1.94595 | 18.0 | |
| 15 | −34.97140 | Variable | | | |
| 16(Diaphragm) | ∞ | 0.30000 | | | |
| 17* | 5.38550 | 2.53220 | 1.52500 | 70.3 | |
| 18* | −21.78410 | 1.19260 | | | |
| 19 | 393.52310 | 1.46680 | 1.62299 | 58.1 | |
| 20 | −6.50510 | 0.01000 | 1.56732 | 42.8 | |
| 21 | −6.50510 | 0.40000 | 1.68400 | 31.3 | |
| 22* | 21.75740 | Variable | | | |
| 23 | 14.90260 | 0.50000 | 1.68400 | 31.3 | |
| 24* | 9.36130 | Variable | | | |
| 25* | 10.65080 | 1.96890 | 1.52500 | 70.3 | |
| 26* | −161.06680 | Variable | | | |
| 27 | ∞ | 0.80000 | 1.51680 | 64.2 | |
| 28 | ∞ | (BF) | | | |
| Image surface | ∞ | | | | |

TABLE 17
(Aspherical data)

Surface No. 10
K = 0.00000E+00, A4 = −2.50186E−04, A6 = 1.89904E−05,
A8 = −4.28290E−07 A10 = 3.13969E−09, A12 = 0.00000E+00
Surface No. 11
K = 0.00000E+00, A4 = −4.11341E−04, A6 = −1.24082E−05,
A8 = 2.31818E−06 A10 = −5.62141E−08, A12 = 0.00000E+00
Surface No. 17
K = 0.00000E+00, A4 = −2.60711E−04, A6 = −1.54333E−05,
A8 = −1.79727E−07 A10 = −1.81687E−08, A12 = 0.00000E+00
Surface No. 18
K = 0.00000E+00, A4 = 1.11480E−04, A6 = −1.92757E−05,
A8 = 4.35443E−07 A10 = 0.00000E+00, A12 = 0.00000E+00
Surface No. 22
K = 0.00000E+00, A4 = 1.43361E−03, A6 = 6.50976E−05,
A8 = 3.57938E−07 A10 = 1.76149E−07, A12 = 0.00000E+00
Surface No. 24
K = 0.00000E+00, A4 = −3.34731E−05, A6 = −2.66163E−06,
A8 = 4.80103E−07 A10 = −1.57225E−08, A12 = 0.00000E+00
Surface No. 25
K = 0.00000E+00, A4 = −2.96338E−04, A6 = −1.39817E−05,
A8 = 4.45637E−07 A10 = −1.78822E−08, A12 = −8.58883E−10
Surface No. 26
K = 0.00000E+00, A4 = −3.91800E−04, A6 = −1.56251E−05,
A8 = 5.28450E−07 A10 = −3.71474E−08, A12 = 0.00000E+00

TABLE 18
(Various data)
Zooming ratio 15.16095

| | Wide-angle | Middle | Telephoto |
|---|---|---|---|
| | limit | position | limit |
| Focal length | 4.6500 | 18.6000 | 70.4984 |
| F-number | 3.39024 | 4.56790 | 6.10029 |
| View angle | 41.2581 | 11.9876 | 3.1079 |
| Image height | 3.5000 | 3.9000 | 3.9000 |
| Overall length | 51.6501 | 59.9101 | 73.7790 |
| of lens system | | | |
| BF | 0.50161 | 0.48757 | 0.45096 |
| d7 | 0.5000 | 1.0000 | 1.5000 |
| d9 | 0.3000 | 9.5738 | 20.5444 |
| d15 | 16.9500 | 4.7170 | 0.8768 |
| d22 | 1.0000 | 11.7333 | 18.0083 |
| d24 | 5.9457 | 2.6083 | 6.4427 |
| d26 | 3.8529 | 7.1902 | 3.3559 |
| Entrance pupil | 13.8511 | 35.4103 | 112.9079 |
| position | | | |
| Exit pupil | −28.3376 | −56.2016 | 346.3474 |
| position | | | |
| Front principal | 17.7513 | 47.9075 | 197.7747 |
| points position | | | |
| Back principal | 47.0001 | 41.3100 | 3.2806 |
| points position | | | |

Zoom lens unit data

| Lens | Initial | Focal |
|---|---|---|
| unit | surface No. | length |
| 1 | 1 | 43.00014 |
| 2 | 8 | 340.40023 |
| 3 | 10 | −5.84709 |
| 4 | 16 | 10.46298 |
| 5 | 23 | −38.20729 |
| 6 | 25 | 19.10415 |

The following Table 19 and Table 20 show the corresponding values to the individual conditions in the zoom lens systems of each of Numerical Examples.

TABLE 19
(Values corresponding to conditions)

| Numerical | Condition | | | | |
|---|---|---|---|---|---|
| Example | (1) | (2) | (3) | (4) | (a) |
| 1 | 1.1944 | 0.95 | 0.48 | 12.83 | 15.16 |
| 2 | 1.0961 | 0.96 | 0.51 | 15.28 | 18.39 |
| 3 | 1.2455 | 1.23 | 0.66 | 11.84 | 22.92 |
| 4 | 1.0831 | 0.77 | 0.44 | 14.46 | 29.05 |
| 5 | 1.0237 | 0.68 | 0.37 | 16.64 | 34.33 |
| 6 | 1.2993 | 1.24 | 0.73 | 35.25 | 15.16 |

TABLE 20
(Values corresponding to conditions)

Condition

| | | |
|---|---|---|
| Numerical | Lens | (5) |

| Example | element | I | II | (6) |
|---|---|---|---|---|
| 1 | L1 | −0.0547 | — | −0.1031 |
| | L3 | 0.4208 | — | 0.3698 |
| | L8 | 0.0619 | — | 0.0131 |
| 2 | L3 | — | 0.3682 | 0.2335 |
| | L11 | — | 0.6173 | −0.0957 |
| 3 | L5 | 0.4894 | — | 0.4171 |
| | L8 | −0.0547 | — | −0.1031 |
| 4 | L5 | 0.4208 | — | 0.3698 |
| | L16 | — | 0.6173 | −0.0957 |
| 5 | L5 | 0.4208 | — | 0.3698 |
| | L16 | — | 0.6173 | −0.0957 |
| 6 | L3 | 0.4208 | — | 0.3698 |

The following Table 21 shows the composition of each fine particle dispersed material and the optical properties of the fine particle dispersed material. The optical properties are the refractive index (nd) to the d-line, the Abbe number (vd) to the d-line, and the partial dispersion ratio (θgF) that is the ratio of a difference between a refractive index to the g-line and a refractive index to the F-line, to a difference between a refractive index to the F-line and a refractive index to the C-line. The materials used in each Numerical Example are exemplified as the fine particle dispersed materials shown in Table 21.

TABLE 21
(Fine particle dispersed materials)

| | Inorganic particles | | | | | |
|---|---|---|---|---|---|---|
| | | Volume | Fine particle dispersed material | | | Numerical Example |
| Resin | Kinds | fraction | nd | vd | θgF | (Lens element) |
| Cycloolefin | ZrO₂ | 0.05 | 1.56341 | 51.8 | 0.617 | 2(L11), 4(L16), 5(L16) |
| polymer | | 0.2 | 1.65971 | 44.8 | 0.695 | |
| | | 0.5 | 1.83722 | 39.0 | 0.761 | |
| | BaTiO₃ | 0.05 | 1.58761 | 31.7 | 0.732 | |
| | | 0.2 | 1.74919 | 17.7 | 0.819 | |
| | | 0.5 | 2.03420 | 12.9 | 0.841 | |
| Poly (methyl | ITO | 0.01 | 1.49530 | 46.8 | 0.481 | |
| methacrylate) | (In₂O₃ + SnO₂) | 0.05 | 1.51632 | 27.2 | 0.368 | 2(L3) |
| | | 0.2 | 1.59266 | 12.2 | 0.281 | 1(L3), 4(L5), 5(L5), 6(L3) |
| | | 0.5 | 1.73531 | 7.3 | 0.249 | 3(L5) |
| Polycarbonate | TiO₂ | 0.05 | 1.66231 | 20.4 | 0.714 | |
| | | 0.2 | 1.87806 | 13.1 | 0.751 | 1(L1), 3(L8) |
| | | 0.5 | 2.24830 | 10.4 | 0.758 | |
| | ZnO | 0.05 | 1.60235 | 25.9 | 0.648 | |
| | | 0.2 | 1.65656 | 18.3 | 0.642 | |
| | | 0.5 | 1.75998 | 12.9 | 0.635 | 1(L8) |

The present disclosure is applicable to a digital input device, such as a digital camera, a camera for a mobile terminal device such as a smart-phone, a surveillance camera in a surveillance system, a Web camera or a vehicle-mounted camera. In particular, the present disclosure is applicable to a photographing optical system where high image quality is required like in a digital camera.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A zoom lens system having a plurality of lens units, each lens unit comprising at least one lens element,
the zoom lens system, in order from an object side to an image side, comprising:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies,
the following condition (a) is satisfied, and
at least one lens element among all the lens elements constituting the lens system satisfies the following condition (1):
((φ_{1G}g−φ_{1G}F)+0.0018×φ_{1G}d)/(φ_{1G}F−φ_{1G}C)>0.8978 (1)
f_{T}/f_{W}>10.5 (a)
where
φ_{1G}n is a refractive power to the n-line of the first lens unit (“n” is “d”, “F”, “C”, or “g”),
f_{W} is a focal length of the entire system at a wide-angle limit, and
f_{T} is a focal length of the entire system at a telephoto limit.

2. The zoom lens system as claimed in claim 1, wherein the following condition (2) is satisfied:
0.20<(L_{T}×f_{w})/(H_{T}×f_{T})<1.31 (2)
where
L_{T} is an overall length of lens system at a telephoto limit (an optical axial distance from an object side surface of a lens element positioned closest to the object side in the lens system, to an image surface),
f_{W} is a focal length of the entire system at a wide-angle limit,
f_{T} is a focal length of the entire system at a telephoto limit, and
H_{T} is an image height at a telephoto limit.

3. The zoom lens system as claimed in claim 1, wherein the following condition (3) is satisfied:
0.10<(f₁×f_{w})/(H_{T}×f_{T})<0.73 (3)
where
f₁ is a focal length of the first lens unit,
f_{W} is a focal length of the entire system at a wide-angle limit,
f_{T} is a focal length of the entire system at a telephoto limit, and
H_{T} is an image height at a telephoto limit.

4. The zoom lens system as claimed in claim 1, wherein
a second lens unit is located closest to the object side in the subsequent lens units, and
the following condition (4) is satisfied:
11.76<f_{T}/M₂<70.00 (4)
where
f_{T} is a focal length of the entire system at a telephoto limit, and
M₂ is an optical axial thickness of the second lens unit (an optical axial distance from an object side surface of a most object side lens element to an image side surface of a most image side lens element).

5. The zoom lens system as claimed in claim 1, wherein
at least one of the lens elements constituting the first lens unit is a lens element made of a fine particle dispersed material.

6. The zoom lens system as claimed in claim 1, wherein
at least one of the lens elements constituting the first lens unit satisfies the following condition (5) or (6):
I) when vd<23
0.0002399×vd²−0.0123×vd+0.8157−θgF<0
II) when 23≦vd<80
θgF>0.66
III) when 80≦vd
0.00003815×vd²−0.006314×vd+0.8239−θgF<0 (5)
−0.00325×vd+0.69−θgF>0 (6)
where
vd is an Abbe number to the d-line of the lens element, and
θgF is a partial dispersion ratio of the lens element, that is a ratio of a difference between a refractive index to the g-line and a refractive index to the F-line, to a difference between the refractive index to the F-line and a refractive index to the C-line.

7. An imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system is a zoom lens system as claimed in claim 1.

8. A camera for converting an optical image of an object into an electric image signal and then performing at least one of displaying and storing of the converted image signal, comprising:
an imaging device including a zoom lens system that forms an optical image of the object and an image sensor that converts the optical image formed by the zoom lens system into the electric image signal, wherein
the zoom lens system is a zoom lens system as claimed in claim 1.
